(19) United States
(12) Patent Application Publication
(10) Pub. No.: US 2016/0267424 A1
(43) Pub. Date: Sep. 15, 2016

(54) Managing Employee Information Using an Information Management System

(71) Applicant: ADP, LLC, Roseland, NJ (US)

(72) Inventors: Teena Singh, Brooklyn, NY (US); Michael Morgan, New York, NY (US); Robert Martin Tucker, New York, NY (US); Alexei Zagdansky, Cliffside Park, NJ (US); Ian Patrick Morris, London (GB); Keith Wilson Fulton, South Orange, NJ (US)

(21) Appl. No.: 14/643,569

(22) Filed: Mar. 10, 2015

(51) Int. Cl. G06Q 10/06; G06F 3/0481; G06T 11/20; G06F 3/0484

(52) U.S. Cl. CPC G06Q 10/063114; G06F 3/04847; G06F 3/04817; G06T 11/206; G06T 2200/24

(57) ABSTRACT

A method and apparatus for managing employee information. A timeline for chronologically presenting events corresponding to an employee and a main section for presenting the employee information are displayed in a graphical user interface on a display system. The employee information for the employee may be stored in a database. The employee information stored in the database may be modified based on user input received through the graphical user interface. A number of graphical elements representing a number of events corresponding to the may be displayed in association with the timeline in the graphical user interface on the display system.

### BACKGROUND INFORMATION

1. Field

The present disclosure relates generally to employee information and, in particular, to managing employee information using a computer system. Still more particularly, the present disclosure relates to a method and apparatus for managing employee information displayed in association with a timeline in a graphical user interface on a display system.

2. Background

Information management systems may be used for different purposes. For example, a payroll system may be an example of one type of employee information system. A payroll system typically processes payroll to generate paychecks for employees in an organization. A human resources department may use a different type of employee information system to manage employee benefits information and other records about employees. For example, a human resources department may use an employee information system to manage employee health insurance, wellness plans, and other types of employee-based programs and plans.

Typically, an employee information system includes a database of records. These records may contain different types of information about the employees of an organization. Further, these records may be searched, viewed, and modified to perform various actions corresponding to the employees. In some cases, one or more records may be added to or deleted from the database. Managing these types of records using currently available employee information systems may be more difficult than desired.

For example, some currently available user interfaces for accessing employee records stored in a database may be more cumbersome and difficult to use than desired. Consequently, accessing employing records to search, view, modify, or otherwise manage these employee records may be more time-consuming and more prone to inconsistencies than desired.

Therefore, it would be desirable to have a method and apparatus for managing employee information that take into account at least some of the issues discussed above, as well as other possible issues. For example, it would be desirable to have a method and apparatus that solve the technical problem of quickly and easily accessing employee information.

### SUMMARY

In one illustrative example, a method is provided for managing employee information. A timeline for chronologically presenting events corresponding to an employee and a main section for presenting the employee information are displayed in a graphical user interface on a display system. The employee information for the employee may be stored in a database. The employee information stored in the database may be modified based on user input received through the graphical user interface. A number of graphical elements representing a number of events corresponding to the may be displayed in association with the timeline in the graphical user interface on the display system. The timeline provides a temporal context for the employee information that allows a user to more quickly and easily access the employee information.

In another illustrative example, a method is provided for managing member information about members of an organization. A computer system displays a timeline that represents at least a portion of a timescale in a graphical user interface on a display system. The computer system displays a graphical element that visually presents a portion of the member information about an event in association with the timeline based on a relationship between the event and the timescale in the graphical user interface on the display system. The computer system updates the graphical element based on user input received through the graphical user interface. The timeline provides a temporal context for the member information that allows a user to more quickly and easily access the member information.

In yet another illustrative example, a computer system comprises a display system and an information manager. The information manager is in communication with the display system. The information manager identifies a relationship between an event corresponding to a member of an organization and a timescale. The information manager displays a timeline that represents at least a portion of the timescale in a graphical user interface on the display system. The information manager displays a graphical element that includes a set of details about the event in association with the timeline in the graphical user interface on the display system.

In still yet another illustrative example, a computer system comprises a display system and an information manager. The information manager is in communication with the display system. The information manager displays a timeline for chronologically presenting events corresponding to an employee and a main section for presenting employee information on a graphical user interface on the display system. The information manager modifies the employee information for the employee stored in a database based on user input received through the graphical user interface. The information manager updates a number of graphical elements representing a number of events corresponding to the employee that are displayed in association with the timeline in the graphical user interface on the display system.

In another illustrative example, a computer program product for managing employee information comprises a computer readable storage media and first, second, and third program code stored on the computer readable storage media. The first program code is provided for identifying a relationship between an event corresponding to a member of an organization and a timescale. The second program code is provided for displaying a timeline that represents at least a portion of the timescale using a graphical user interface on a display system. The third program code is provided for displaying a graphical element that includes a set of details about the event in association with the timeline in the graphical user interface on the display system.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is an illustration of an information management system in the form of a block diagram in accordance with an illustrative embodiment;

FIG. 2 is an illustration of a graphical user interface in accordance with an illustrative embodiment;

FIG. 3 is an illustration of the modifying of employee information in accordance with an illustrative embodiment;

FIG. 4 is an illustration of the addition of graphical elements to a timeline in accordance with an illustrative embodiment;

FIG. 5 is an illustration of the modifying of employee information in accordance with an illustrative embodiment;

FIG. 6 is an illustration of the addition of a graphical element to a timeline in accordance with an illustrative embodiment;

FIG. 7 is an illustration of user interaction with graphical user interface in accordance with an illustrative embodiment;

FIG. 8 is an illustration of new information being displayed within a main section of a graphical user interface in accordance with an illustrative embodiment;

FIG. 9 is an illustration of the modifying of employee information in accordance with an illustrative embodiment;

FIG. 10 is an illustration of the selection of an effective end date in accordance with an illustrative embodiment;

FIG. 11 is an illustration of an addition of a graphical element to a timeline in accordance with an illustrative embodiment;

FIG. 12 is an illustration of new information and a different timeline displayed in a graphical user interface in accordance with an illustrative embodiment;

FIG. 13 is an illustration of new event information being added for a new allowance event through a graphical user interface in accordance with an illustrative embodiment;

FIG. 14 is an illustration of new event information being added for a new allowance event through a graphical user interface in accordance with an illustrative embodiment;

FIG. 15 is an illustration of event information being modified in accordance with an illustrative embodiment;

FIG. 16 is an illustration of an update to a graphical element in accordance with an illustrative embodiment;

FIG. 17 is an illustration of new event information being added for a new allowance event through a graphical user interface in accordance with an illustrative embodiment;

FIG. 18 is an illustration of a visual presentation of a conflict in accordance with an illustrative embodiment;

FIG. 19 is an illustration of an insertion action in accordance with an illustrative embodiment;

FIG. 20 is an illustration of a completion of an insertion action in accordance with an illustrative embodiment;

FIG. 21 is an illustration of a replacement action in accordance with an illustrative embodiment;

FIG. 22 is an illustration of a completion of a replacement action in accordance with an illustrative embodiment;

FIG. 23 is an illustration of a process for managing member information in the form of a flowchart in accordance with an illustrative embodiment;

FIG. 24 is an illustration of a process for managing employee information in the form of a flowchart in accordance with an illustrative embodiment;

FIG. 25 is an illustration of a process for displaying a new graphical element in association with a timeline in the form of a flowchart in accordance with an illustrative embodiment;

FIG. 26 is an illustration of a process for managing a conflict in the form of a flowchart in accordance with an illustrative embodiment; and

FIG. 27 is an illustration of a data processing system in the form of a block diagram in accordance with an illustrative embodiment.

### DETAILED DESCRIPTION

The illustrative embodiments recognize and take into account one or more different considerations. The illustrative embodiments recognize and take into account that it may be desirable to have a graphical user interface for displaying employee information in association with a timeline. In particular, the illustrative embodiments recognize and take into account that displaying employee information in association with a timeline may provide a more user-friendly approach to enabling a user to access the employee information.

Thus, the illustrative embodiments provide a method and apparatus for accessing employee information stored in a database. The employee information may be, for example, without limitation, searched, viewed, edited, added, deleted, or managed in some other manner using a graphical user interface for displaying the employee information. In particular, the employee information may be displayed in association with a timeline. User input may be received by user manipulation of graphical features associated with the timeline. This user input may be used to modify the employee information stored in a database in any of a number of different ways. In this manner, the different illustrative examples enable a user to quickly and easily access the database and the employee information stored in the database using the timeline and the graphical features associated with the timeline.

In one illustrative example, a computer-implemented method is provided for managing employee information. A timeline for chronologically presenting events corresponding to an employee and a main section for presenting the employee information are displayed in a graphical user interface on a display system. The employee information for the employee may be stored in a database. The employee information stored in the database may be modified based on user input received through the graphical user interface. One or more graphical elements representing a number of events corresponding to the may be displayed in association with the timeline in the graphical user interface on the display system.

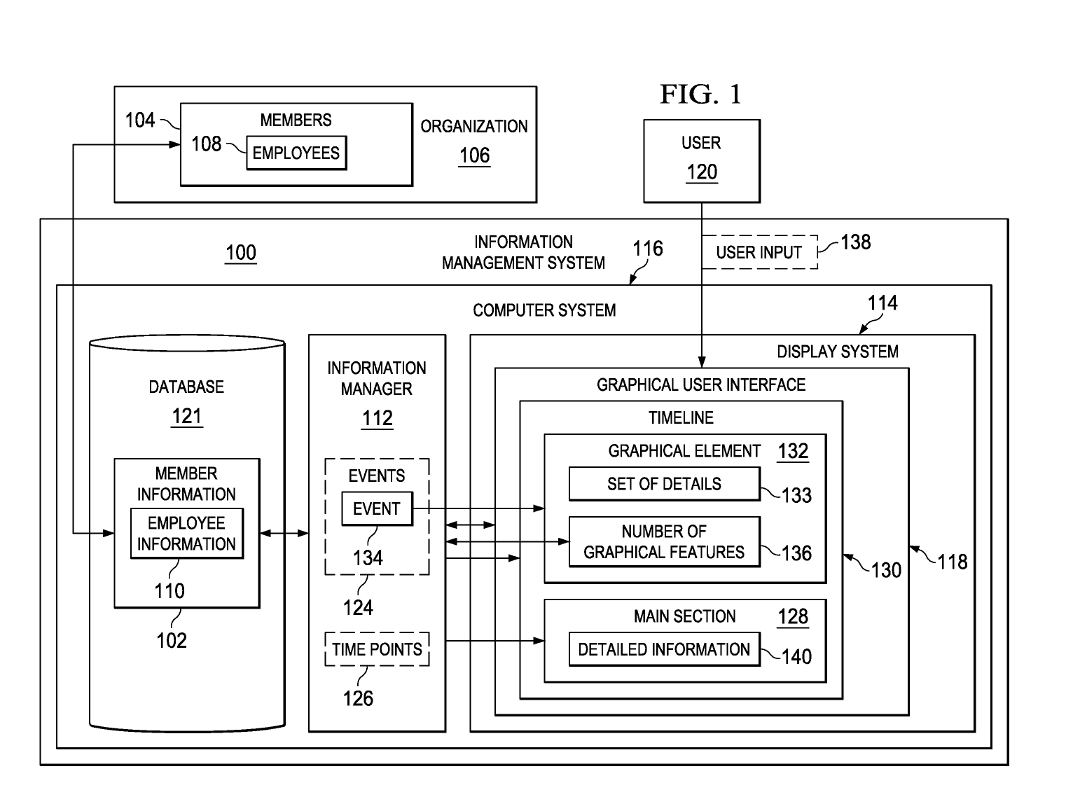

Referring now to the figures, and in particular, with reference to FIG. 1, an illustration of an information management system is depicted in the form of a block diagram in accordance with an illustrative embodiment. Information management system 100 may be an example of a system that may be used to manage member information 102.

Member information 102 includes information about members 104 of organization 106. Organization 106 may take the form of a corporation, a social group, a charity, an intramural group, an enterprise, or some other type of entity that has a group of members. Members 104 are people that belong to or are otherwise associated with organization 106.

In one illustrative example, members 104 take the form of employees 108. When members 104 take the form of employees 108, member information 102 may be referred to as employee information 110. In other illustrative examples, members 104 may take the form of contract employees, volunteers, team members, event participants, department managers, guests, hosts, or some combination thereof.

As depicted, information management system 100 includes information manager 112 and display system 114. Information manager 112 may be implemented using software, hardware, firmware, or a combination thereof. When software is used, the operations performed by information manager 112 may be implemented using, for example, without limitation, program code configured to run on a processor unit. When firmware is used, the operations performed by information manager 112 may be implemented using, for example, without limitation, program code and data and stored in persistent memory to run on a processor unit.

When hardware is employed, the hardware may include one or more circuits that operate to perform the operations performed by information management system 100. Depending on the implementation, the hardware may take the form of a circuit system, an integrated circuit, an application-specific integrated circuit (ASIC), a programmable logic device, or some other suitable type of hardware device configured to perform any number of operations.

A programmable logic device may be configured to perform certain operations. The device may be permanently configured to perform these operations or may be reconfigurable. A programmable logic device may take the form of, for example, without limitation, a programmable logic array, programmable array logic, a field programmable logic array, a field programmable gate array, or some other type of programmable hardware device.

In some illustrative examples, the operations and/or processes performed by information management system 100 may be performed using organic components integrated with inorganic components. In some cases, the operations, processes, or both may be performed by entirely organic components, excluding a human being. As one illustrative example, circuits in organic semiconductors may be used to perform these operations, processes, or both.

In one illustrative example, information manager 112 is implemented in computer system 116. Computer system 116 is a hardware system that includes one or more data processing systems. When more than one data processing system is present, these one or more data processing systems may be in communication with each other using a communications medium. The communications medium may be a network. The one or more data processing systems may include at least one of a computer, a server computer, a tablet, or some other suitable data processing system.

As used herein, the phrase “at least one of,” when used with a list of items, means different combinations of one or more of the listed items may be used and only one of the items in the list may be needed. The item may be a particular object, thing, or category. In other words, “at least one of” means any combination of items or number of items may be used from the list, but not all of the items in the list may be required.

For example, “at least one of item A, item B, and item C” may mean item A; item A and item B; item B; item A, item B, and item C; or item B and item C. In some cases, “at least one of item A, item B, and item C” may mean, for example, without limitation, two of item A, one of item B, and ten of item C; four of item B and seven of item C; or some other suitable combination.

Information manager 112 and display system 114 are in communication with each other. In one illustrative example, display system 114 is a hardware system that includes one or more display devices. These one or more display devices may include at least one of a light emitting diode display (LED), a liquid crystal display (LCD), organic light emitting diode display (OLED), a touchscreen display, or some other suitable device.

In one illustrative example, display system 114 is considered part of computer system 116. In other illustrative examples, display system 114 may be considered separate from but in communication with computer system 116. Further, depending on the implementation, display system 114 may also be implemented using software, firmware, or both, in addition to hardware.

Information manager 112 displays graphical user interface 118 on display system 114. Graphical user interface 118 may enable user 120 to access member information 102. In these illustrative examples, accessing member information 102 includes at least one of searching, reviewing, modifying, editing, deleting, adding, filtering, categorizing, or otherwise accessing member information 102. In one illustrative example, member information 102 may be stored in database 121. Of course, in other illustrative examples, member information 102 may be stored across one or more databases, data storage systems, servers, or other types of data storage schemes or devices.

In one illustrative example, graphical user interface 118 enables user 120 to access member information 102 based on timescale 122. Timescale 122 is range of time. In other words, timescale 122 may be a selected period of time. The selected period of time may be in the range of, for example, without limitation, hours, days, weeks, months, years, or decades, depending on the type of member information 102 being managed.

As one illustrative example, timescale 122 is the range of time that begins with a selected past date and that definitively extends to some future date or that indefinitely extends into the future. The selected past date may be, for example, without limitation, the inception of organization 106, an opening day, the beginning of a hiring period, or some other type of past date.

In another illustrative example, timescale 122 is the period of time between a selected past data and a current date. In still another illustrative example, timescale 122 is the period of time between a specific time of day on a selected date and another specific time of day on the same selected date or a different selected date.

Member information 102 may include information about events 124 corresponding to members 104. Events 124 may be associated with time points 126 that fall along timescale 122. A time point may be defined using a clock time, a calendar date, some other measure of time, or some combination thereof. A clock time may include, for example, without limitation, a measurement in at least one of hours, minutes, seconds, or some other unit of time. A calendar date may include at least one of a day, a month, a year, or some other unit of time with respect to a reference calendar system. The time point associated with a particular one of events 124 indicates the relationship between the event and timescale 122. For example, the time point may mark a start of the event, an end of the event, an effective start date for the event, an effective end date for the event, an occurrence of the event, or some other type of time-related factor with respect to timescale 122.

Information manager 112 displays main section 128 and timeline 130 in graphical user interface 118 on display system 114. Main section 128 is an area in graphical user interface 118 used to present member information 102 for one or more of members 104, for one or more of events 124 corresponding to one or more of members 104, or both.

In this illustrative example, timeline 130 is a graphical object displayed in graphical user interface 118 within an area in graphical user interface 118 selectively positioned relative to main section 128. Timeline 130 may be selectively positioned relative to main section 128 to enhance and improve the user experience. Timeline 130 is a graphical object that includes any number of graphical user interface elements that provide access to member information 102 with respect to a temporal context. These graphical user interface elements may include any number of and combination of structural elements and interactive elements.

Further, timeline 130 is a graphical object that is displayed in graphical user interface 118 to represent at least a portion of timescale 122 in graphical user interface 118 on display system 114. Timeline 130 may be displayed in graphical user interface 118 in a number of different ways. For example, displaying timeline 130 may include displaying at least one of a linear element, a curved bar, a circular bar, or some other type of visual element to represent at least a portion of timescale 122 in graphical user interface 118.

Timeline 130 is used to chronologically present event information in graphical user interface 118. Chronologically presenting the event information may include presenting the event information about the events in a chronological order with respect to timescale 122. This event information may include information about one or more of events 124 corresponding to one or more of members 104. In particular, timeline 130 displayed in graphical user interface 118 is used to visually present at least a portion of timescale 122 in a manner that enables user 120 to quickly and easily grasp the temporal context of event information about events displayed in association with timeline 130.

In one illustrative example, information manager 112 displays graphical element 132 in association with timeline 130 in graphical user interface 118. Graphical element 132 represents event 134 by visually presenting event information about event 134 in association with timeline 130.

Event 134 may correspond to a particular member of members 104 in one illustrative example. Event 134 may take a number of different forms. Event 134 may take the form of, for example, but is not limited to, a creation of an allowance, an employee hiring, an employee termination, a change in job title, a change in salary, a change in address, a change in tax filing status, a change in bonus eligibility, a change in bonus structure for an employee, an addition of a new member to organization 106, a new member leaving organization 106, or some other type of event. In other illustrative examples, event 134 may be the occurrence of a selected number of sub-events. In this manner, event 134 may be the combination of multiple events.

The positioning of graphical element 132 relative to timeline 130 in graphical user interface 118 may be based on the identification of a relationship between event 134 and timescale 122. Identifying this relationship may include identifying a time point associated with event 134 with respect to timescale 122. The time point may be, for example, without limitation, a start time point for event 134, an end time point for event 134, or some other time point associated with event 134 with respect to timescale 122.

Graphical element 132 represents event 134 using number of graphical features 136. As used herein, a “number of” items may include one or more items. In this manner, number of graphical features 136 may include one or more graphical features.

A graphical feature, such as one of number of graphical features 136, may be any visual element, object, or software component that visually represents information or enables interaction with user 120. Number of graphical features 136 may include, for example, but is not limited to, a text object, a date object, a symbol, an image, a control feature, an icon, a graphical indicator, or some other type of graphical object, feature, element, or sub-element. A control feature may take the form of, for example, without limitation, a button, a menu, a link, a tab, a scrollbar, a check box, a radio button, a slider, a spinner, or some other type of control feature that facilitates a user-computer interaction through graphical user interface 118.

In some illustrative examples, at least one of number of graphical features 136 is used to visually present set of details 133 corresponding to event 134. Each detail in set of details 133 is a piece of information about event 134 that is stored in database 122 as part of member information 102.

A detail in set of details 133 may take the form of, for example, without limitation, an identification of event 134, an identification of a factor or parameter affected by event 134, or some other type of information. In some cases, a detail in set of details 133 may take the form of an employment status, an allowance amount, an address, an age, a marital status, an education level, a job title, an experience level, a compensation level, bonus information, a tenure status, a start date, an effective start date, an end date, an effective end date, or some other type of detail related to event 134. For example, when event 134 is a change in job title, set of details 133 may include the previous job title, the new job title, or both.

In one illustrative example, information manager 112 receives user input 138 through the interaction between user 120 and a number of control features within graphical element 132. Depending on the implementation, user input 138 may be received through graphical user interface 118, a number of input devices in communication with at least one of graphical user interface 118 or information manager 112, or some combination thereof. In this example, information manager 112 changes at least one detail of set of details 133 about event 134 stored in database 121 based on user input 138 to form a modified set of details. Changing a detail may include modifying that detail or deleting that detail. In some cases, information manager 112 visually presents the modified set of details within graphical element 132 in graphical user interface 118 on display system 114. In some examples, information manager 112 changes an appearance of graphical element 132 in addition to visually presenting the modified set of details within graphical element 132. For example, information manager 112 may at least one of change a text color of graphical element 132, change a background color of graphical element 132, or display some other type of visual indication that set of details 133 has been modified.

In another illustrative example, user input 138 is a selection of event 134 that corresponds to one of members 104. In this example, information manager 112 displays detailed information 140 corresponding to that event within main section 128 in graphical user interface 118 based on user input 138. Detailed information 140 displayed in main section 128 may be a portion of member information 102 stored in database 121.

Detailed information 140 may include set of details 133 and, in some cases, additional pieces of information. For example, without limitation, detailed information 140 may include at least one of an employment status, an allowance amount, an address, an age, a marital status, an education level, a job title, an experience level, a compensation level, bonus information, a tenure status, a start date, an effective start date, an end date, an effective end date, or some other piece of information.

In one illustrative example, information manager 112 displays timeline 130 in graphical user interface 118 for chronologically presenting events corresponding to a particular one of members 104 and main section 128 in graphical user interface 118 for presenting detailed information 140 corresponding to the member. In this example, information manager 112 receives user input 138 from user 120 through graphical user interface 118. Information manager 112 modifies detailed information 140 stored in database 121 based on user input 138. Based on the modification of detailed information 140 stored in database 121, information manager 112 updates graphical element 132 representing event 134, detailed information 140 displayed in main section 128, or both.

The chronological presentation of events 124 corresponding to members 104 in association with timeline 130 in graphical user interface 118 allows user 120 to much more easily access member information 102 stored in database 121. Interaction with the graphical elements displayed in association with timeline 130 in graphical user interface 118 allows user 120 to selectively view different portions of member information 102 stored in database 121 within main section 128 in graphical user interface 118. User 120 may then selectively modify any number of pieces of member information 102 stored in database 121.

The graphical elements displayed in association with timeline 130 in graphical user interface 118 allow user 120 to more easily and efficiently navigate through member information 102 stored in database 121. In this manner, this type of graphical user interface 118 having timeline 130 serves as an innovative navigation tool that enables a user, such as user 120, to easily and quickly access member information 102.

In these illustrative examples, computer system 116 may operate as a special purpose computer system in which information manager 112 and graphical user interface 118 implemented in computer system 116 enable the efficient management of member information 102 for members 104 of organization 106. In particular, information manager 112 and graphical user interface 118 transform computer system 116 into a special purpose computer system as compared to currently available general computer systems that have neither information manager 112 nor graphical user interface 118.

Information manager 112 transforms member information 102 stored in database 121 such that details about different events may be chronologically presented in association with timeline 130 in graphical user interface 118. Information manager 112, together with graphical user interface 118, provides a technical solution to the problems associated with quickly and easily accessing and managing member information 102 about members 104 of organization 106 given a temporal context for member information 102. Further, by presenting pieces of member information 102 in association with timeline 130 in graphical user interface 118 in a manner that enables a user, such as user 120, to interact with and temporally navigate through member information 102, information manager 112 provides a more user-friendly solution to the management of member information 102.

The illustration of information management system 100 in FIG. 1 is not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment. For example, although database 121 is depicted as being part of computer system 116 in FIG. 1, database 121 may be located remotely with respect to computer system 116 in other illustrative examples.

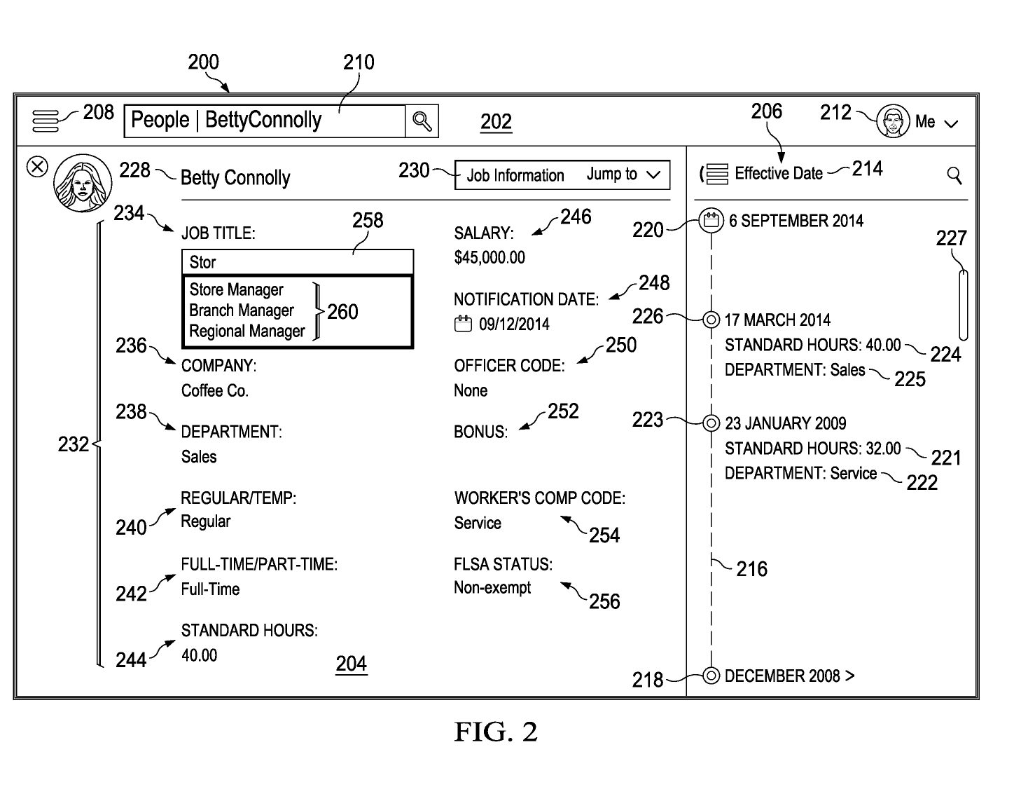

With reference now to FIG. 2, an illustration of a graphical user interface is depicted in accordance with an illustrative embodiment. Graphical user interface 200 is an example of one implementation for graphical user interface 118 in FIG. 1. Graphical user interface 200 is used to display information, such as employee information 110 about employees 108, in FIG. 1.

As depicted, graphical user interface 200 includes section 202, main section 204, and timeline 206. Main section 204 and timeline 206 are examples of implementations for main section 128 and timeline 130, respectively, in FIG. 1.

Section 202 includes menu control feature 208, search feature 210, and user image 212. In one illustrative example, a user input selection of menu control feature 208 causes a pop-up window (not shown) to be displayed in graphical user interface 200. The pop-up window may include, for example, a number of menu options for selection by a user.

Search feature 210 enables a user to search for a particular employee such that employee information about that particular employee may be displayed within main section 204. User image 212 is an image of the user.

Timeline 206 represents at least a portion of a timescale corresponding to an effective date, as indicated by text 214. In some illustrative examples, the effective date of an event may also be the effective start date for the event. The effective start date is one of a number of options for categories for which a corresponding timescale may be represented by timeline 206.

In this illustrative example, timeline 206 includes linear element 216. Linear element 216 is a vertical line in this illustrative example. Linear element 216 represents the portion of a timescale ranging from a first date represented by date object 218 to a second date represented by date object 218. Timeline 206 also includes scrollbar 227 that allows a user to change the portion of the timescale that is represented in timeline 206.

Graphical element 221, graphical element 222, graphical element 224, and graphical element 225 are displayed in association with timeline 206. Each of graphical element 221, graphical element 222, graphical element 224, and graphical element 225 is an example of one implementation for graphical element 132 in FIG. 1.

Graphical element 221 and graphical element 222 are displayed in association with timeline 206 under date object 223 associated with linear element 216. Graphical element 221 and graphical element 222 correspond to events that have the effective start date indicated by date object 223. Similarly, graphical element 224 and graphical element 225 are displayed in association with timeline 206 under date object 226 associated with linear element 216. Graphical element 224 and graphical element 225 correspond to events that have the effective start date indicated by date object 226.

Each of graphical element 221, graphical element 222, graphical element 224, and graphical element 225 visually presents a detail identifying information about the event represented by that graphical element. These graphical elements are positioned relative to linear element 216 within timeline 206 in a manner that chronologically presents the events represented by these graphical elements.

The events represented by graphical element 221, graphical element 222, graphical element 224, and graphical element 225 correspond to the employee identified by employee identification 228 displayed in main section 204. Within main section 204, menu 230 enables different types of employee information about the employee to be selected. In this illustrative example, job information is selected. As a result, job information section 232 is displayed within main section 204.

As depicted, job information section 232 includes job title section 234, company section 236, department section 238, regular or temporary status section 240, full-time or part-time status section 242, standard hours requirement section 244, salary section 246, notification date section 248, officer code section 250, bonus information section 252, worker's compensation code section 254, and Fair Labor Standards Act (FLSA) status section 256. The text displayed within each of these sections identifies the relevant employee information corresponding to that section. The various sections and text displayed in job information section 232 are depicted for illustrative purposes only. In other illustrative examples, other pieces of information about the employee may be displayed within main section 204 in addition to or in place of the pieces of information shown.

In this illustrative example, event information for a new event is being generated through user interaction with graphical user interface 200. The new event is a change in job title. A user enters user input through text box 258 in job title section 234 in graphical user interface 200. Entering this user input prompts the display of job title menu 260, from which a new job title for the employee may be selected. A selection of one of the options in job title menu 260 results in a modification to the job title stored in the database and the text displayed in job title section 234.

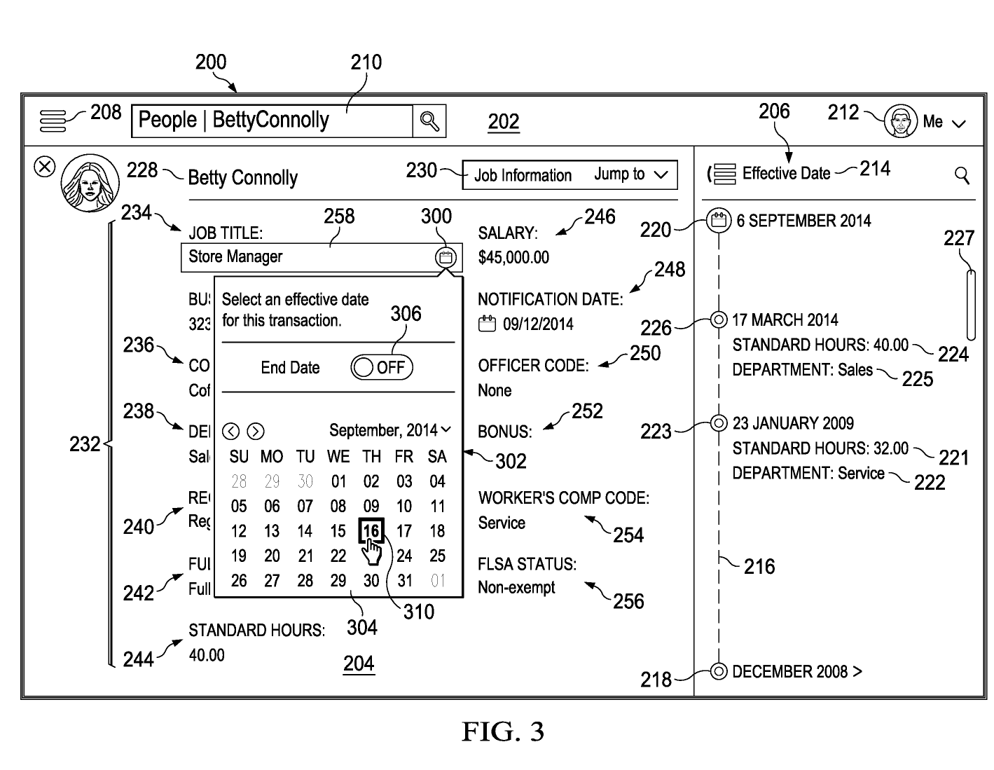

With reference now to FIG. 3, an illustration of the modifying of employee information is depicted in accordance with an illustrative embodiment. In this illustrative example, an effective start date is selected for the new event described in FIG. 2 above. In particular, an effective start date is selected for the change in job title. The updated text in job title section 234 reflects the change in job title.

Control feature 300 is displayed in job title section 234. A selection of control feature 300 by user input may enable the selection of an effective start date for the change in job title. In particular, as depicted, a selection of control feature 300 causes pop-up window 302 to be displayed over main section 204. Pop-up window 302 includes interactive calendar 304 and toggle control 306.

In this illustrative example, user input may be received selecting date object 310 through interactive calendar 304. This selection identifies the effective start date for the change in job title. Information identifying the change in job title and the effective start date for the change in job title are added to the employee information stored in the database. Toggle control 306 is in an “off” state indicating that no effective end date is required.

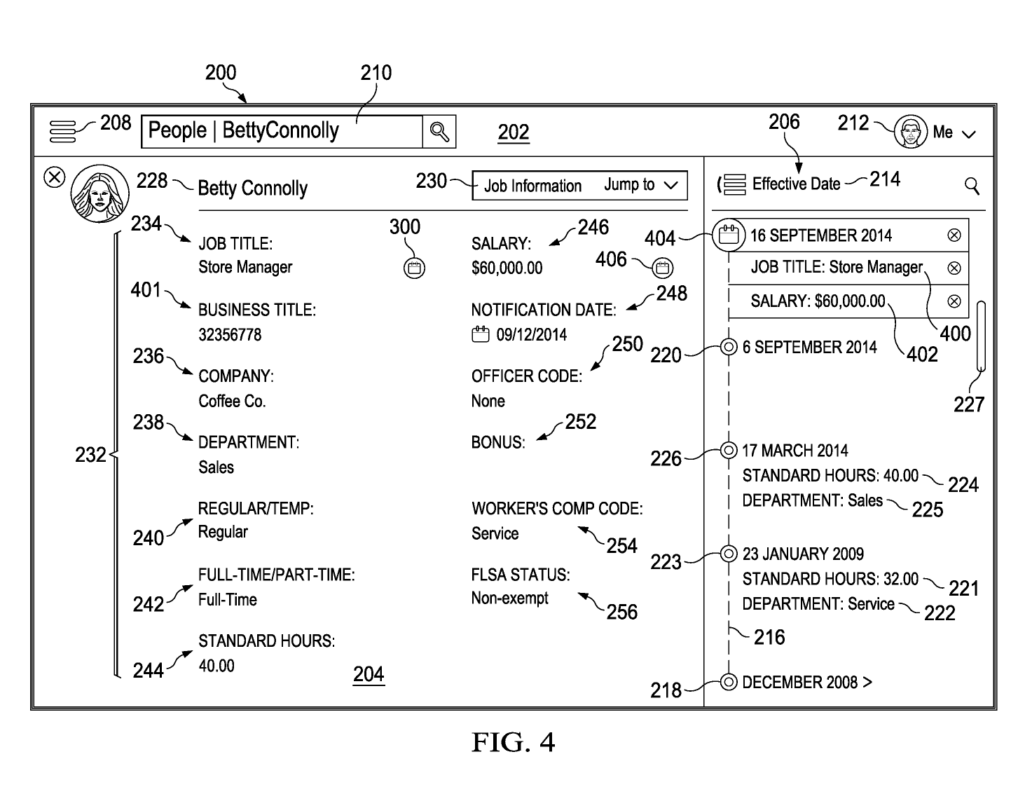

Turning now to FIG. 4, an illustration of the addition of graphical elements to timeline 206 from FIG. 3 is depicted in accordance with an illustrative embodiment. In this illustrative example, business title section 401 may now be visible in main section 204 in graphical user interface 200.

As depicted, graphical element 400 and graphical element 402 have been added to timeline 206 under date object 404 associated with linear element 216. The positioning of graphical element 400 and graphical element 402 under date object 404 indicates that the events represented by these two graphical elements occurred on the effective start date identified by date object 404.

In this illustrative example, user input may be received selecting date object 404. A selection of date object 404 results in a selection of all graphical elements associated with date object 404. Thus, as depicted, graphical element 400 and graphical element 402 are also shown selected.

Further, the selection of date object 404 results in control feature 300 and control feature 406 being displayed in main section 204. Control feature 300 being displayed within job title section 234 indicates that a change to job title occurs on the effective start date identified by date object 404. Similarly, control feature 406 being displayed within salary section 246 indicates that a change to salary occurs on the effective start date identified by date object 404.

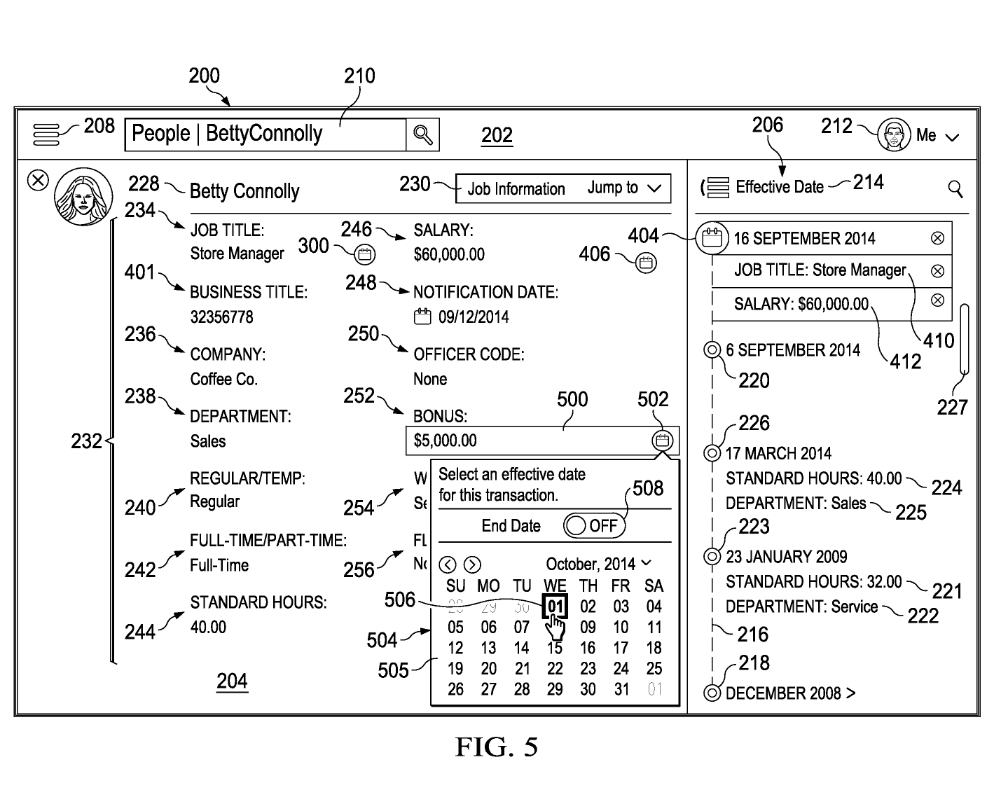

With reference now to FIG. 5, an illustration of the modifying of employee information is depicted in accordance with an illustrative embodiment. In this illustrative example, a new bonus amount has been entered through user input within text box 500 in bonus information section 252 in main section 204. Further, user input selecting control feature 502 is received. This selection results in the display of pop-up window 504 in graphical user interface 200.

Pop-up window 504 includes interactive calendar 505 and toggle control 508. As depicted, user input is received selecting date object 506 in interactive calendar 505. This selection of date object 506 identifies an effective start date, a detail that is added to the employee information stored in the database. Toggle control 508 is in an “off” state indicating that no effective end date is required.

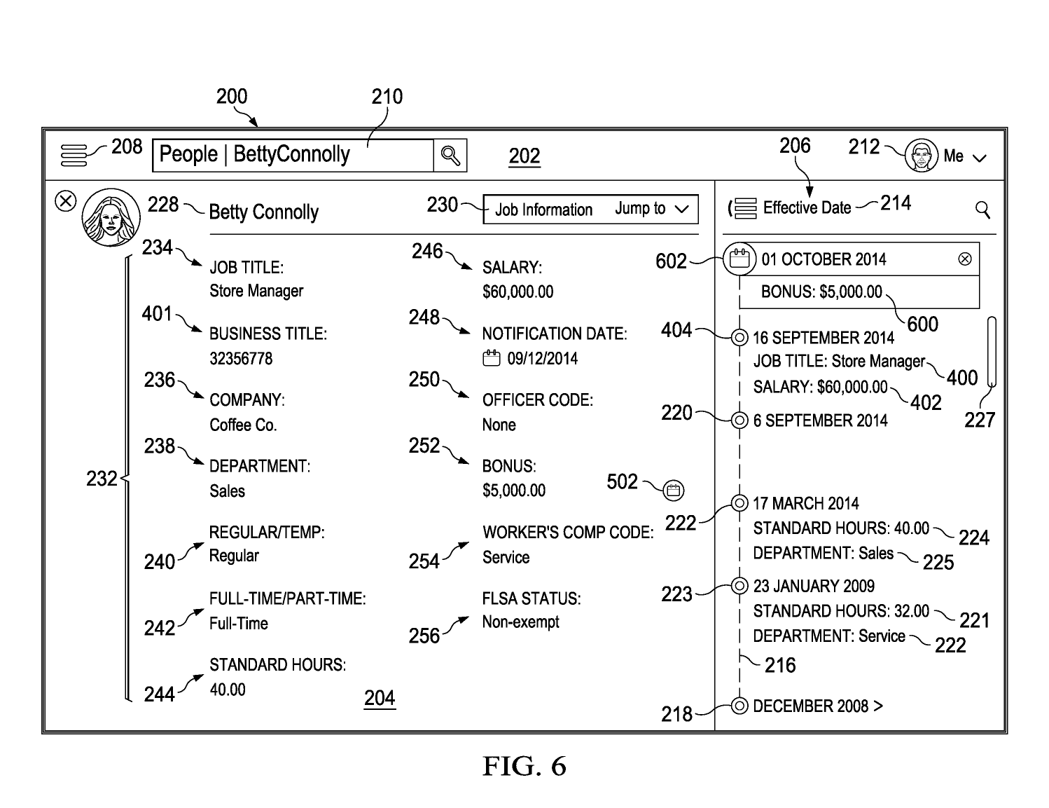

With reference now to FIG. 6, an illustration of the addition of a graphical element to timeline 206 from FIG. 5 is depicted in accordance with an illustrative embodiment. In this illustrative example, graphical element 600 has been added to timeline 206 under date object 602 associated with linear element 216. The positioning of graphical element 600 under date object 602 indicates that the event represented by graphical element 600 has the effective start date identified by date object 602.

In this illustrative example, user input selecting selected date object 602 is received, resulting in a corresponding selection of graphical element 600. Further, the selection of date object 602 results in the display of control feature 502 within bonus information section 252. The display of control feature 502 within bonus information section 252 indicates that a change to the bonus amount occurs on the effective start date identified by date object 602.

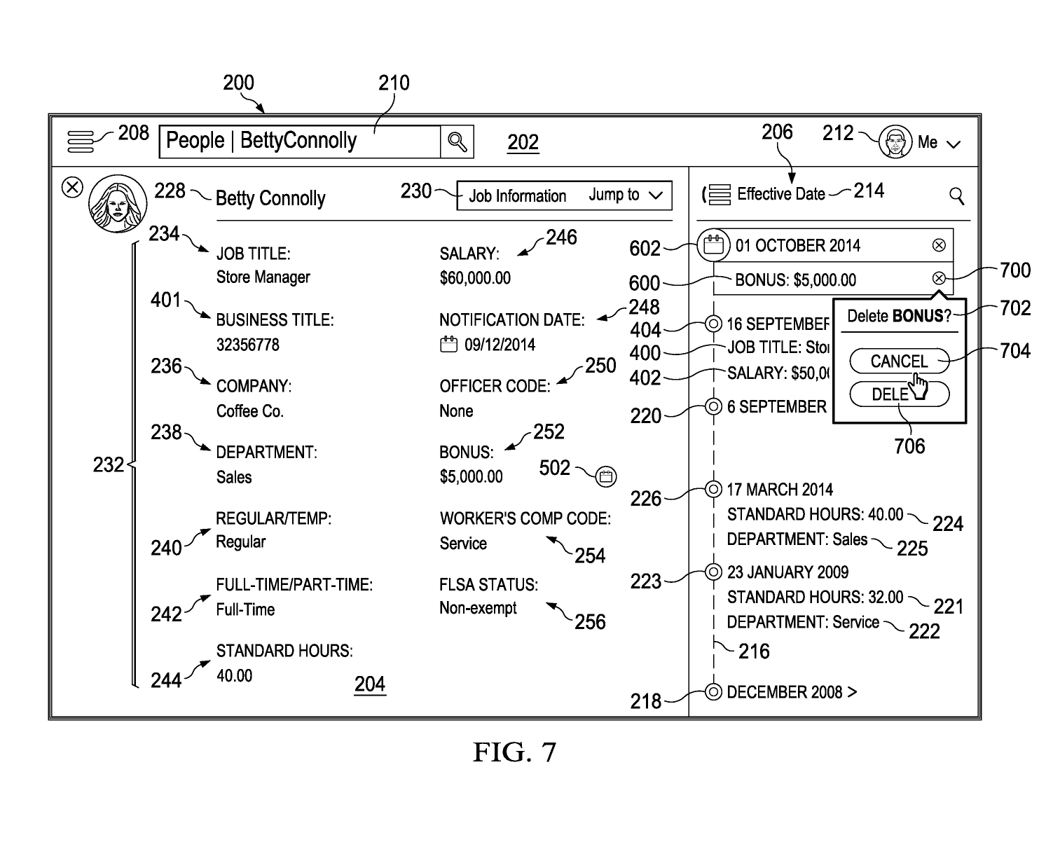

With reference now to FIG. 7, an illustration of user interaction with graphical user interface 200 from FIG. 6 is depicted in accordance with an illustrative embodiment. As depicted, graphical element 600 includes control feature 700. In this illustrative example, user input selecting control feature 700 is received, resulting in the display of pop-up window 702 in graphical user interface 200. Pop-up window 702 includes cancel button 704 and delete button 706.

A selection of cancel button 704 removes pop-up window 702 from graphical user interface 200. A selection of delete button 706 removes graphical element 600 from timeline 206 in graphical user interface 200. Further, in one illustrative example, a selection of delete button 706 also results in the change in the bonus amount represented by graphical element 600 being reversed such that the bonus amount stored in the database reverts back to the previous bonus amount.

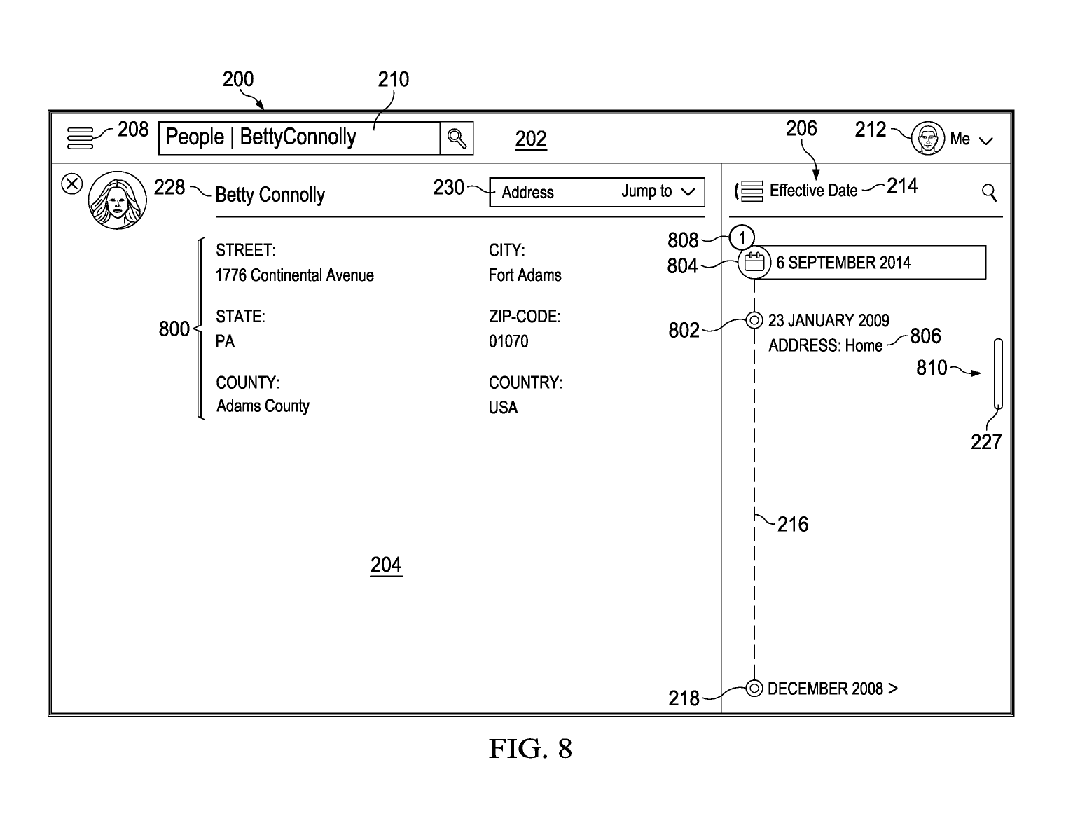

With reference now to FIG. 8, an illustration of new information being displayed within main section 204 of graphical user interface 200 is depicted in accordance with an illustrative embodiment. In this illustrative example, a different option has been selected from menu 230. With the current option selected from menu 230, address information is displayed within address information section 800 in main section 204.

As depicted, date object 802 and date object 804 are depicted in association with linear element 216 within timeline 206. As depicted, graphical element 806 is positioned under date object 802, thereby indicating that the event represented by graphical element 806 has the effective start date identified by date object 802. Date object 804 indicates the latest time point represented in timeline 206 with respect to a timescale, while date object 218 represents the earliest time point represented in timeline 206 with respect to the timescale. Graphical indicator 808 together with position 810 of scrollbar 227 indicates that one event (not shown) has an effective start date that is later in time than the date identified by date object 804.

In this illustrative example, user input selecting date object 804 is received. This selection results in the address information that corresponds to the date identified by date object 804 being displayed in address information section 800.

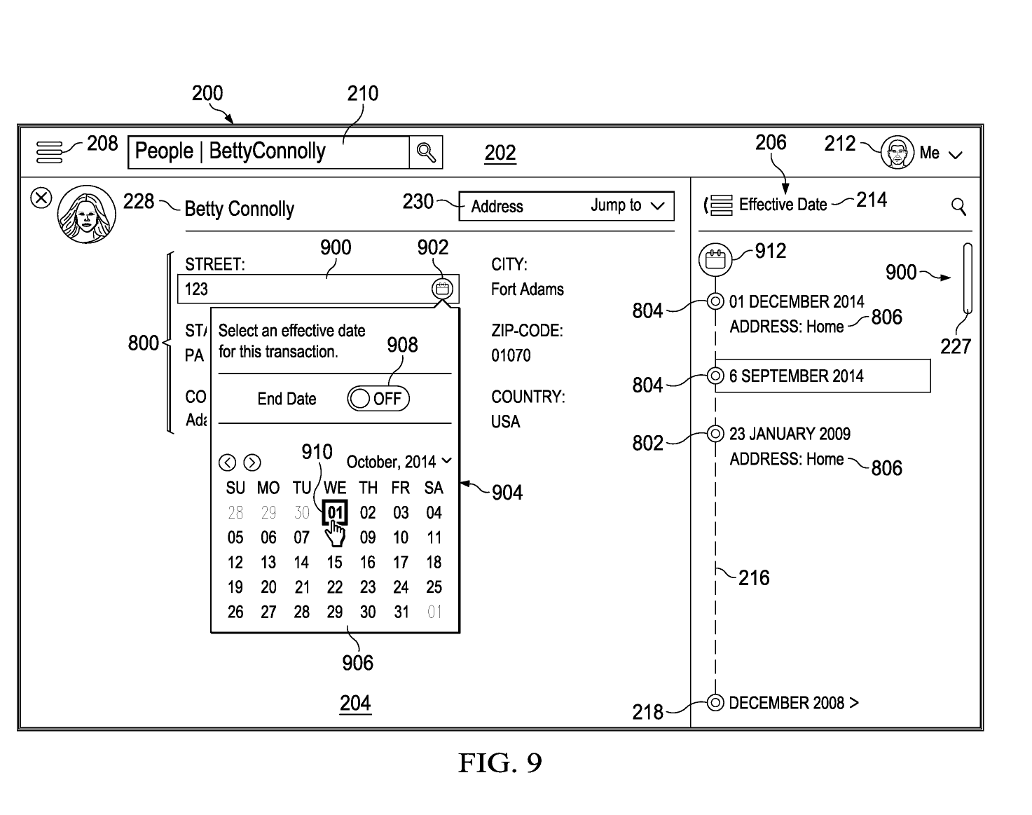

Turning now to FIG. 9, an illustration of the modifying of employee information is depicted in accordance with an illustrative embodiment. In this illustrative example, user input editing the street address in text box 900 may be received for the employee identified by employee identification 228. In this manner, the event may be an address change. A selection of control feature 902 causes pop-up window 904 to be displayed.

As depicted, pop-up window 904 includes interactive calendar 906 and toggle control 908. In this illustrative example, user input is received selecting date object 910 through interactive calendar 906. The selection of date object 910 identifies an effective start date for the address change, a detail which is stored in the database. Toggle control 908 may be manipulated by user input to enable the addition of an effective end date.

Graphical indicator 912 is displayed in association with linear element 216. In this illustrative example, graphical indicator 912 indicates an endpoint of the timescale represented by timeline 206.

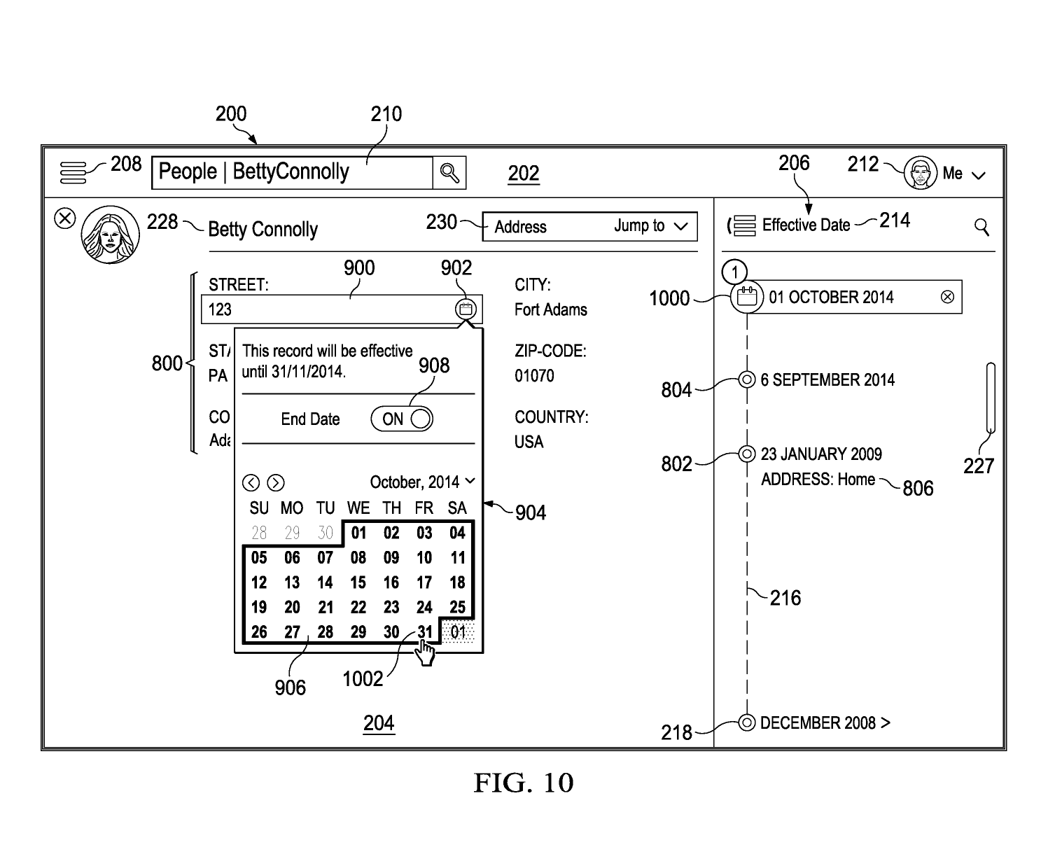

Turning now to FIG. 10, an illustration of the selection of an effective end date is depicted in accordance with an illustrative embodiment. As depicted, the selection of date object 910 in FIG. 9 results in date object 1000 being displayed in association with timeline 206. In particular, date object 1000 is positioned in chronological order with respect to the other date objects shown in association with linear element 216.

In this illustrative example, user input that manipulates toggle control 908 may be received. This user input may place toggle control 908 in an “on” state as compared to the “off” state shown in FIG. 9. With toggle control 908 in the “on” state, the user input may select an effective end date for the new street address added in FIG. 9.

In this illustrative example, user input selecting date object 1002 in interactive calendar 906 is received. This selection results in the identification of an effective end date for the address change, a detail that is stored in the database. Thus, the new street address will be effective from the effective start date described in FIG. 9 until the effective end date in FIG. 10.

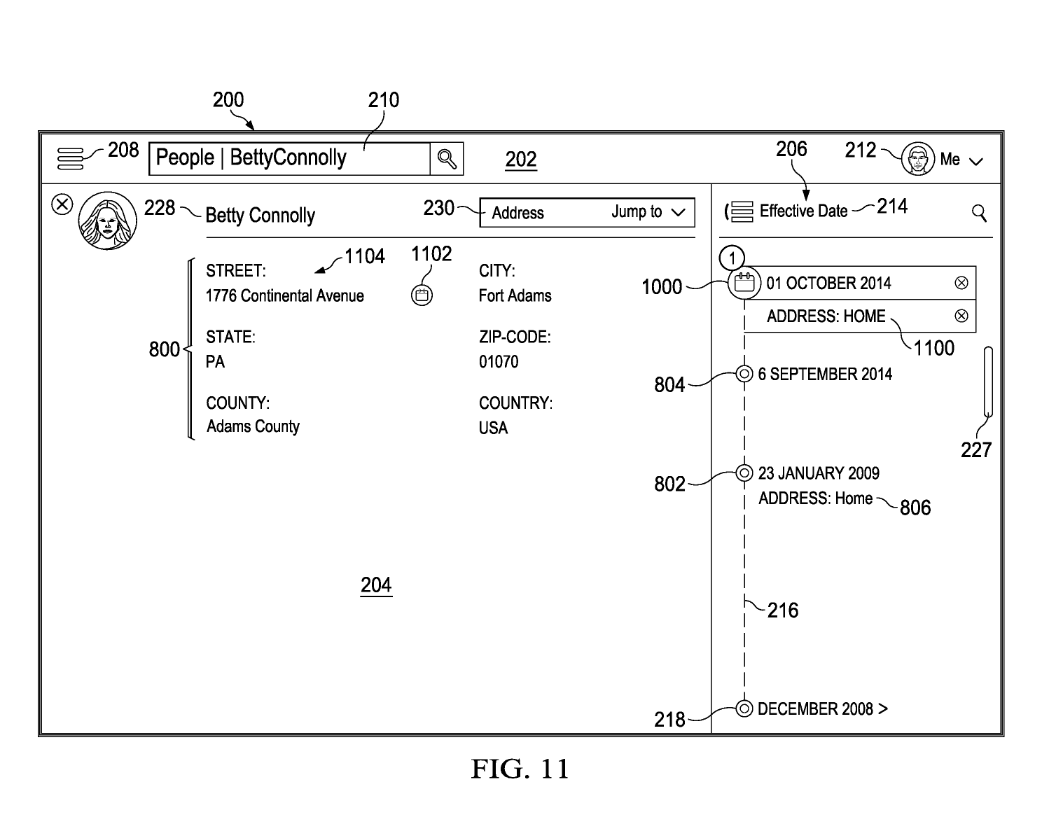

With reference now to FIG. 11, an illustration of an addition of a graphical element to a timeline is depicted in accordance with an illustrative embodiment. In this illustrative example, graphical element 1100 has been added to timeline 206 under date object 1000. Graphical element 1100 includes text identifying a detail about the event represented by graphical element 1100. In particular, the text indicates that a change in the home address for the employee occurs on the effective start date identified by date object 1000.

A selection of date object 1000 results in a selection of graphical element 1100. Further, a selection of date object 1000 results in the display of control feature 1102 adjacent to street address section 1104 in address information section 800.

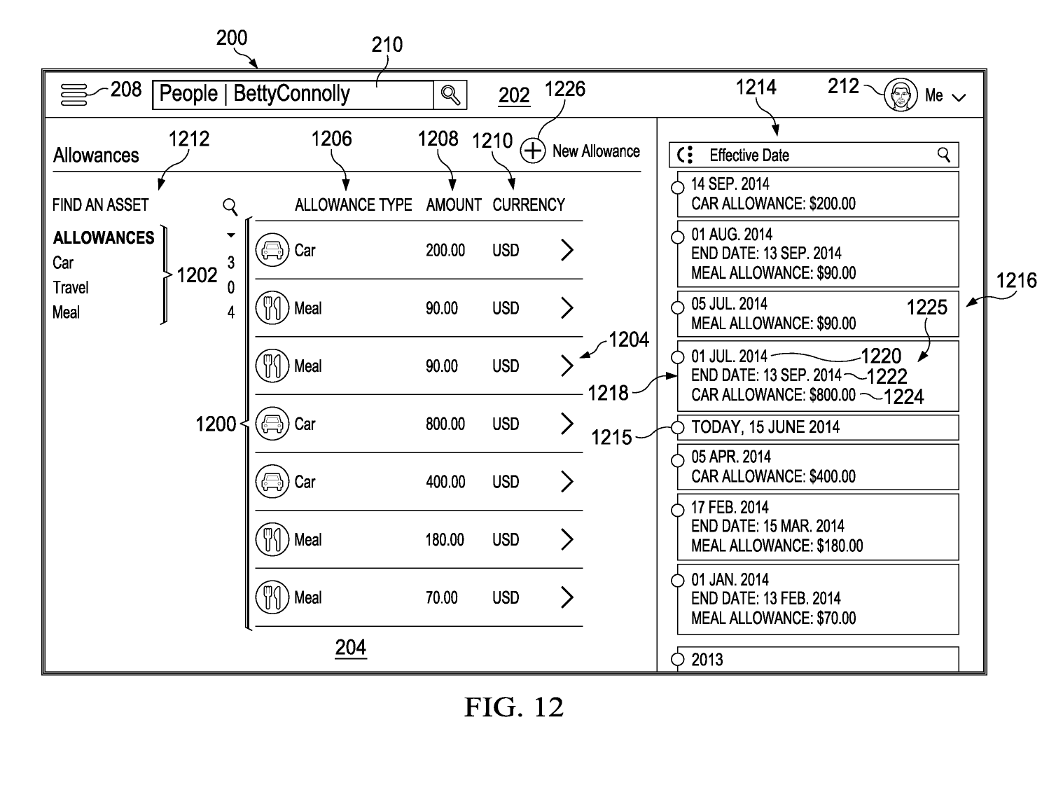

With reference now to FIG. 12, an illustration of new information and a different timeline displayed in graphical user interface 200 is depicted in accordance with an illustrative embodiment. In this illustrative example, information about allowances is displayed in allowance section 1200 within main section 204 in graphical user interface 200. Further, summary allowance information is displayed in summary section 1202 within main section 204.

In this illustrative example, allowance section 1200 includes allowance type column 1206, amount column 1208, and currency column 1210. Allowance event information 1204 is displayed within allowance section 1200.

As depicted, timeline 1214 is displayed in graphical user interface 200. Timeline 1214 may be an example of a different type of implementation for timeline 130 in FIG. 1.

Graphical elements 1216 are displayed in association with timeline 1214. Graphical elements 1216 are displayed in a manner that chronologically presents the events represented by graphical elements 1216 with respect to the effective start dates for these events. In this illustrative example, graphical elements 1216 are positioned within timeline 1214 such that a first event represented by a first graphical element that is positioned above a second graphical element has an effective start date that is later in time than the event represented by the second graphical element that is positioned below the first graphical element.

Date object 1215 identifies the current date and is positioned within timeline 1214 in chronological order among graphical elements 1216. The portion of graphical elements 1216 positioned above date object 1215 indicates that the events represented by this portion of graphical elements 1216 have effective start dates that are later in time than the current date. Conversely, the portion of graphical elements 1216 positioned below date object 1215 indicates that the events represented by this portion of graphical elements 1216 have effective start dates that are earlier in time than the current date.

Graphical element 1218 is an example of one of graphical elements 1216. Graphical element 1218 represents a car allowance event. Graphical element 1218 includes date object 1220, text object 1222, and text object 1224. Date object 1220 is a graphical feature that identifies the time point with respect to the timescale represented by timeline 1214 that corresponds to the car allowance event. In this illustrative example, this time point is the effective start date for the car allowance event. Text object 1222 identifies the effective end date for the car allowance event. Text object 1224 identifies the allowance amount corresponding to the car allowance event.

Graphical element 1218 also includes control feature 1225. Control feature 1225 may be selected by user input to cause a pop-up window (not shown) to be displayed. This pop-up window may present additional options to the user. For example, the pop-up window may include a number of control buttons. In one illustrative example, the pop-up window may provide a number of options to a user to enable the user to at least one of move, edit, delete, or otherwise modify graphical element 1218.

In this illustrative example, control feature 1226 in graphical user interface 200 enables a new allowance event to be created. In particular, in response to receiving user input selecting control feature 1226, the display of main section 204 may be updated such that user input creating new event information for the new allowance event may be received.

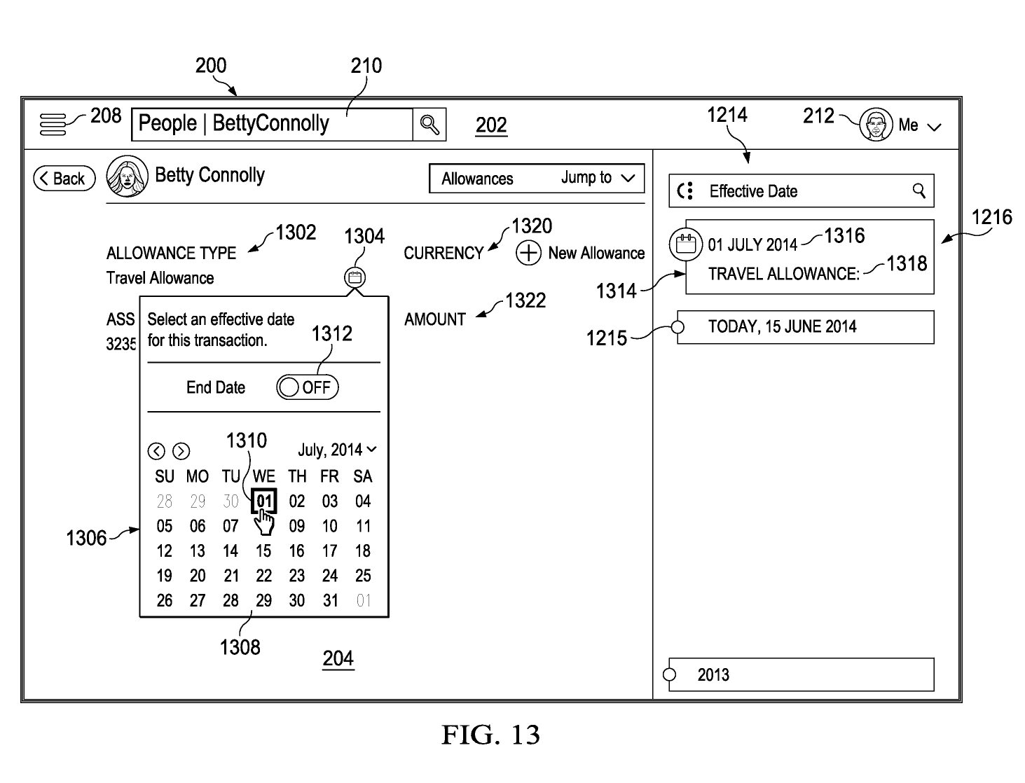

With reference now to FIG. 13, an illustration of new event information being added for a new allowance event through graphical user interface 200 is depicted in accordance with an illustrative embodiment. In this illustrative example, the display of main section 204 from FIG. 12 has been updated based on user input selecting control feature 1226 in FIG. 12. In particular, a new allowance event is being created.

User input identifying the new allowance event as a travel allowance event has been entered through graphical user interface 200 within allowance type section 1302. A selection of control feature 1304 by user input results in the display of pop-up window 1306. Within pop-up window 1306, interactive calendar 1308 and toggle control 1312 are displayed. In this illustrative example, a selection of date object 1310 in interactive calendar 1308 by user input causes an effective start date to be added to the employee information stored in the database for the new travel allowance event.

Further, this selection results in the display of graphical element 1314 in association with timeline 1214. Graphical element 1314 is positioned above date object 1315. Date object 1315 identifies the current date. The placement of graphical element 1314 above date object 1315 enables a user to very quickly and easily ascertain that that event represented by graphical element 1314 has an effective start date that is later in time than the current date.

As depicted, graphical element 1314 includes date object 1316 and text object 1318. Date object 1316 identifies the effective start date for the new travel allowance event. Text object 1318 identifies that the event is a travel allowance event.

In this illustrative example, user input identifying the currency type for the new travel allowance event has not yet been entered within currency section 1320 of main section 204. Similarly, user input identifying the amount for the new travel allowance event has not yet been entered within amount section 1322 of main section 204.

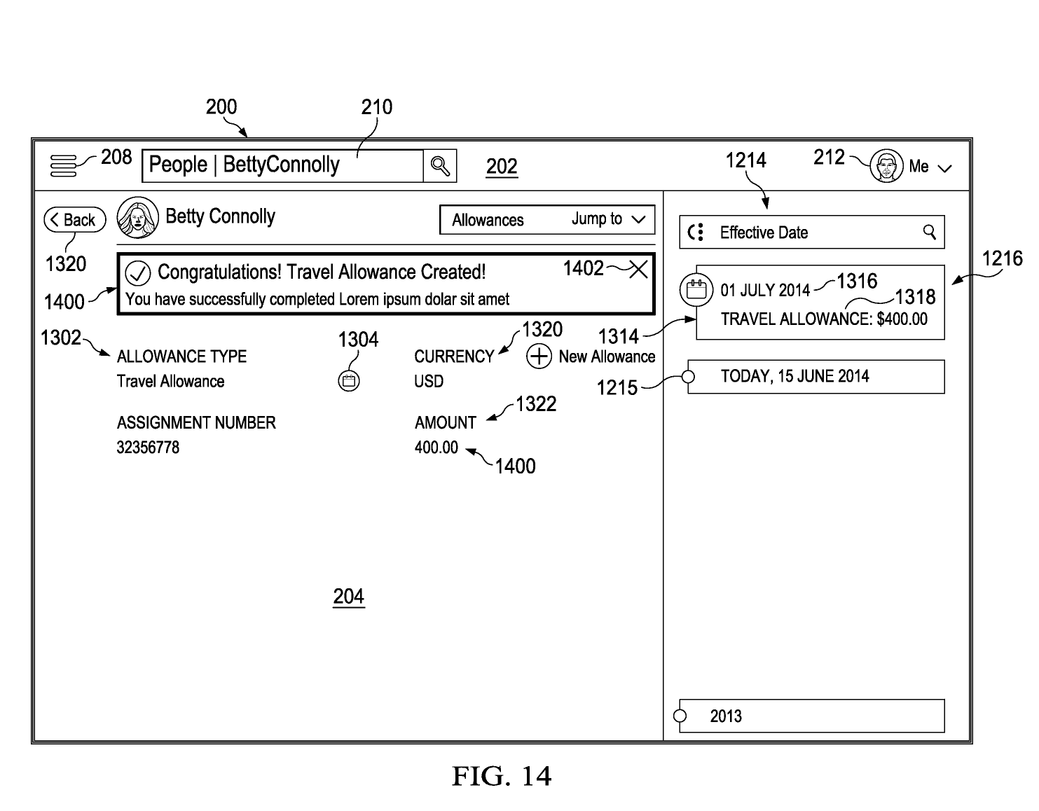

With reference now to FIG. 14, an illustration of new event information being added for a new allowance event through graphical user interface 200 is depicted in accordance with an illustrative embodiment. In this illustrative example, user input identifying the currency type for the new travel allowance event created in FIG. 13 has been entered within currency section 1320. Further, user input identifying the amount for the new travel allowance event has been entered within amount section 1322.

The entry of the amount by user input within amount section 1322 results in the updating of graphical element 1314 representing the new travel allowance event. In particular, text object 1318 is updated to reflect the amount.

The entering of the currency type and the amount for the new travel allowance event completes creation of the new travel allowance event. The details of the new travel allowance event, which include the type of allowance, the effective start date, the currency type, and the amount are added to the employee information stored in the database. The completion of the creating of the new travel allowance event is visually presented in graphical user interface 200 through the display of graphical feature 1400 within main section 204 in graphical user interface 200. Selection of control feature 1402 associated with graphical feature 1400 enables removal of graphical feature 1400 from graphical user interface 200.

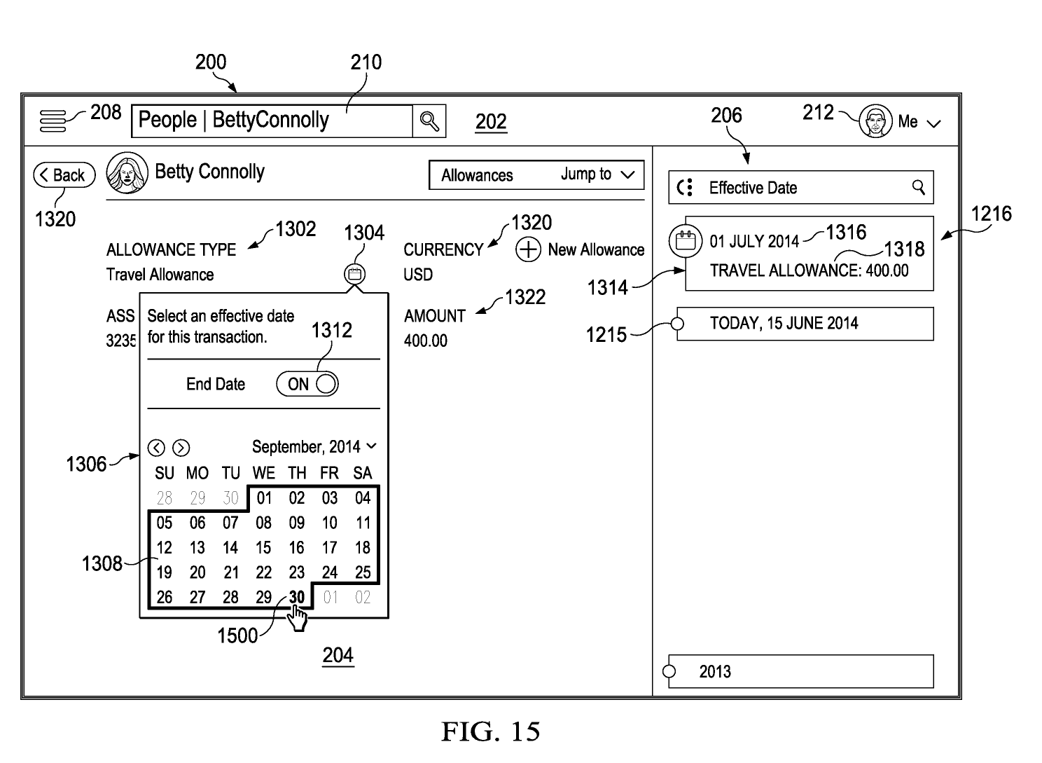

With reference now to FIG. 15, an illustration of event information being modified is depicted in accordance with an illustrative embodiment. In this illustrative example, event information for the travel allowance event described in FIGS. 13-14 is modified.

User input selecting control feature 1304 results in the display of pop-up window 1306 from FIG. 13. Toggle control 1312 may be manipulated by user input to change toggle control 1312 from the “off” state shown in FIG. 13 to the “on” state shown in FIG. 15.

With toggle control 1312 in the “on” state, user input identifying an effective end date for the travel allowance event may be received. As depicted, user input selecting date object 1500 is received through interactive calendar 1308. The selection of date object 1500 identifies an effective start date for the travel allowance event, a detail that is stored in the database.

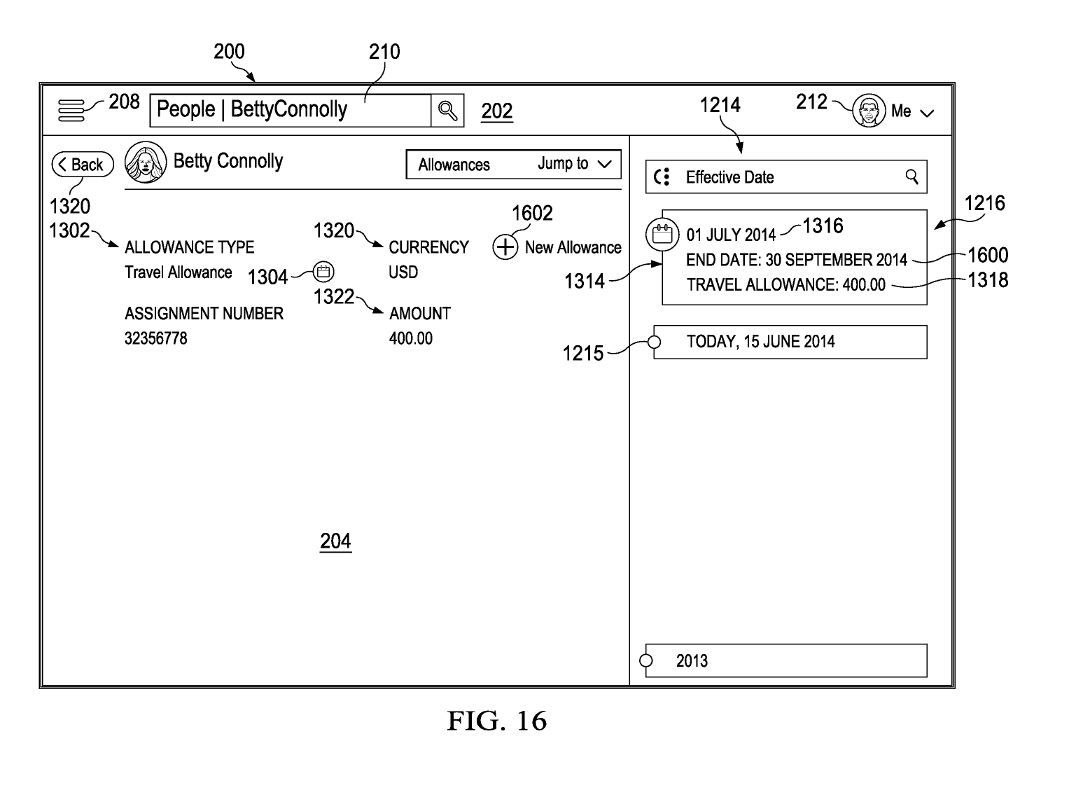

With reference now to FIG. 16, an illustration of an update to a graphical element is depicted in accordance with an illustrative embodiment. In this illustrative example, the identification of an effective end date for the travel allowance event by the user input as described in FIG. 15 results in the addition of text box 1600 to graphical element 1314 representing the travel allowance event. Text box 1600 identifies the effective end date.

As depicted, control feature 1602 is displayed in main section 204 of graphical user interface 200. Yet another new allowance event may be created by a selection of control feature 1602 through user input.

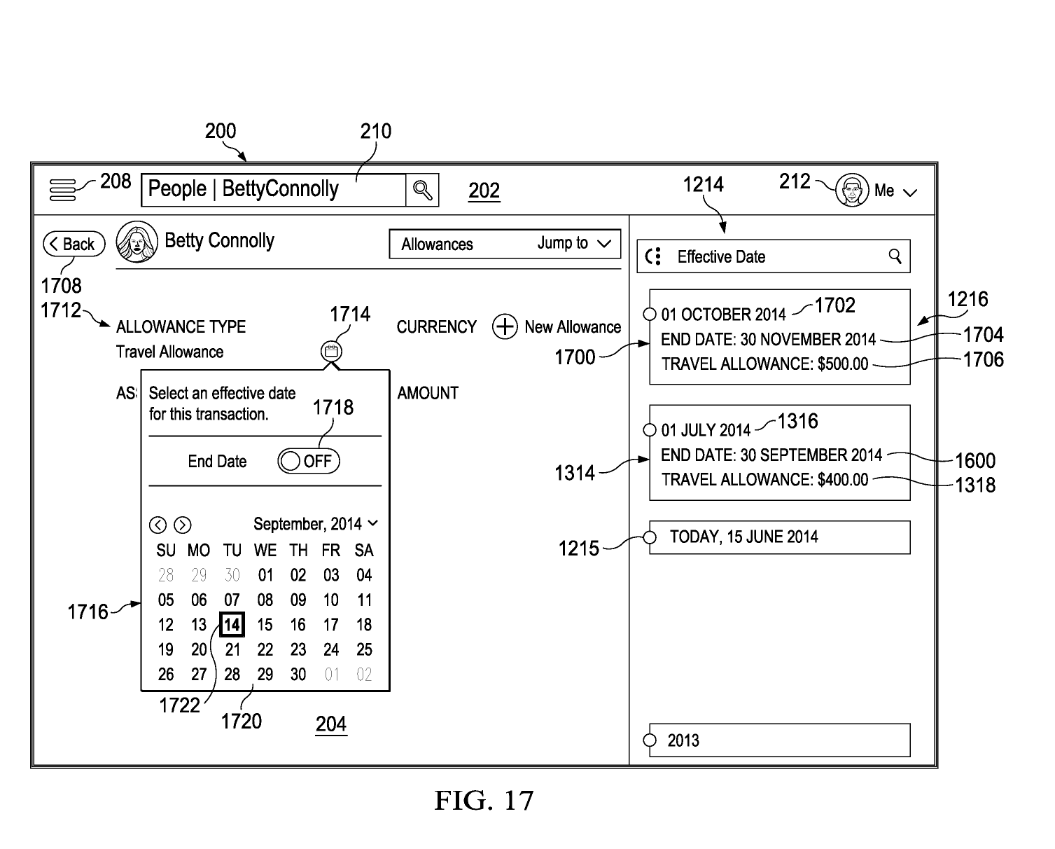

With reference now to FIG. 17, an illustration of new event information being added for a new allowance event through graphical user interface 200 is depicted in accordance with an illustrative embodiment. In this illustrative example, the display of main section 204 from FIG. 16 has been updated based on user input selecting control feature 1602 in FIG. 16. In particular, a new allowance event is being created.

In this illustrative example, date object 1315, graphical element 1314, and graphical element 1700 are displayed in association with timeline 1214. Graphical element 1700 represents a travel allowance event. Graphical element 1700 includes date object 1702, text object 1704, and text object 1706.

In some cases, a user may desire to return to a previous display. A selection of control feature 1708 through user input results in graphical user interface 200 reverting to a previous display.

User input identifying the new allowance event as a travel allowance event has been entered through graphical user interface 200 within allowance type section 1712. A selection of control feature 1714 by user input results in the display of pop-up window 1716. Within pop-up window 1306, toggle control 1718 and interactive calendar 1720 are displayed. In this illustrative example, a selection of date object 1722 in interactive calendar 1720 by user input causes an effective start date to be added to the employee information stored in the database for the new travel allowance event.

As depicted, date object 1722 identifies Sep. 14, 2014, as the effective start date for the new travel allowance event. Although not depicted in this example, user input selecting an effective end date for the new travel allowance event may also be received. The effective end date may be Oct. 10, 2014.

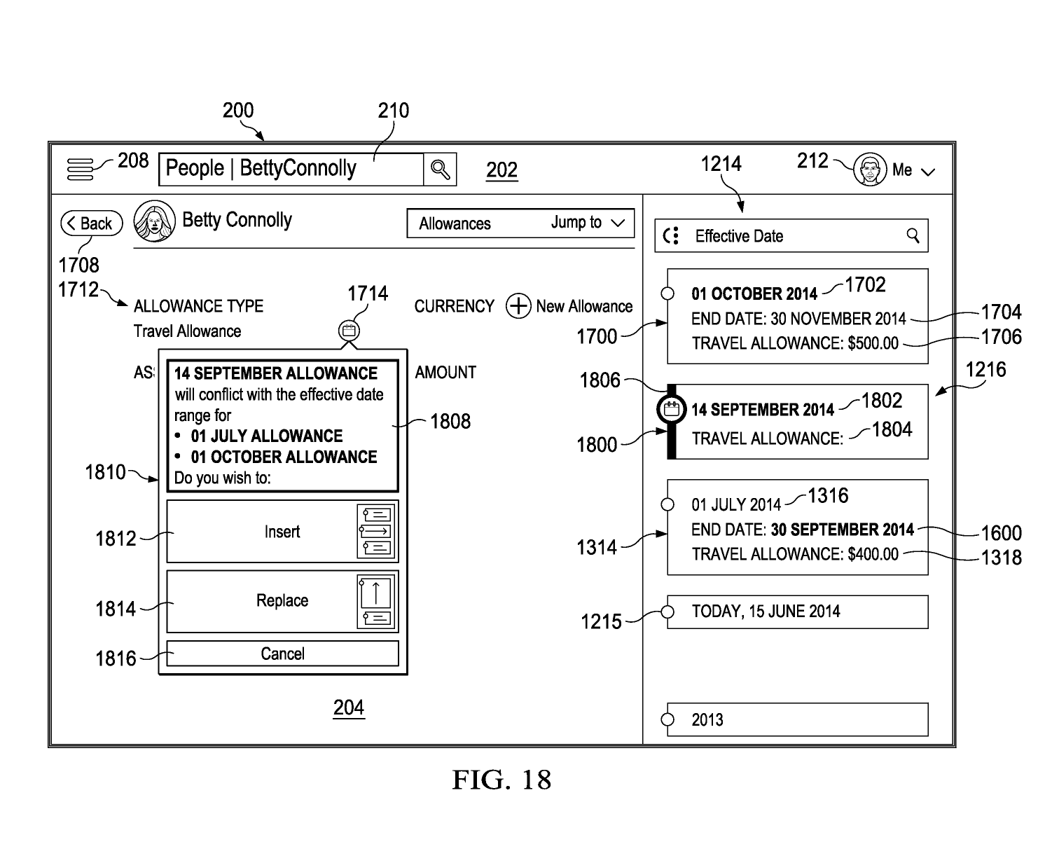

With reference now to FIG. 18, an illustration of a visual presentation of a conflict is depicted in accordance with an illustrative embodiment. In this illustrative example, graphical element 1800 is displayed in association with timeline 1214. Graphical element 1800 represents the new travel allowance event created in FIG. 17. Graphical element 1800 includes date object 1802 and text object 1804.

An effective period for an allowance event is the time period between the effective start date and the effective end date for the allowance event. In this illustrative example, the effective periods for two allowance events may not be allowed to overlap.

The new travel allowance event represented by graphical element 1800 may have an effective period that starts on Sep. 14, 2014, and ends on Oct. 10, 2014. This effective period conflicts with the effective periods for the travel allowance events represented by graphical element 1314 and graphical element 1700.

This conflict is visually presented in graphical user interface 200 using a number of graphical features. As depicted, graphical element 1800 includes graphical feature 1806 that indicates a conflict associated with the new travel allowance event. Further, text box 1600 in graphical element 1314 is updated to have a different font color that indicates that the effective period for the new travel allowance event conflicts with the effective end date identified by text box 1600. Similarly, date object 1702 is updated to have a different font color that indicates that the effective period for the new travel allowance event conflicts with the effective start date identified by date object 1702.

Still further, graphical feature 1808 and a number of control features are displayed within pop-up window 1810 extending from control feature 1714. Graphical feature 1808 includes text that identifies the conflicts associated with the new travel allowance event. The number of control features includes insert button 1812, replace button 1814, and cancel button 1816.

A selection of insert button 1812 by user input will cause the new travel allowance event to be created in a manner that adjusts the effective periods of at least one of the travel allowance events. A selection of replace button 1814 by user input will cause the new travel allowance event to replace the travel allowance event designated with the later effective period. A selection of cancel button 1816 by user input will result in the creation of the new travel allowance event being cancelled.

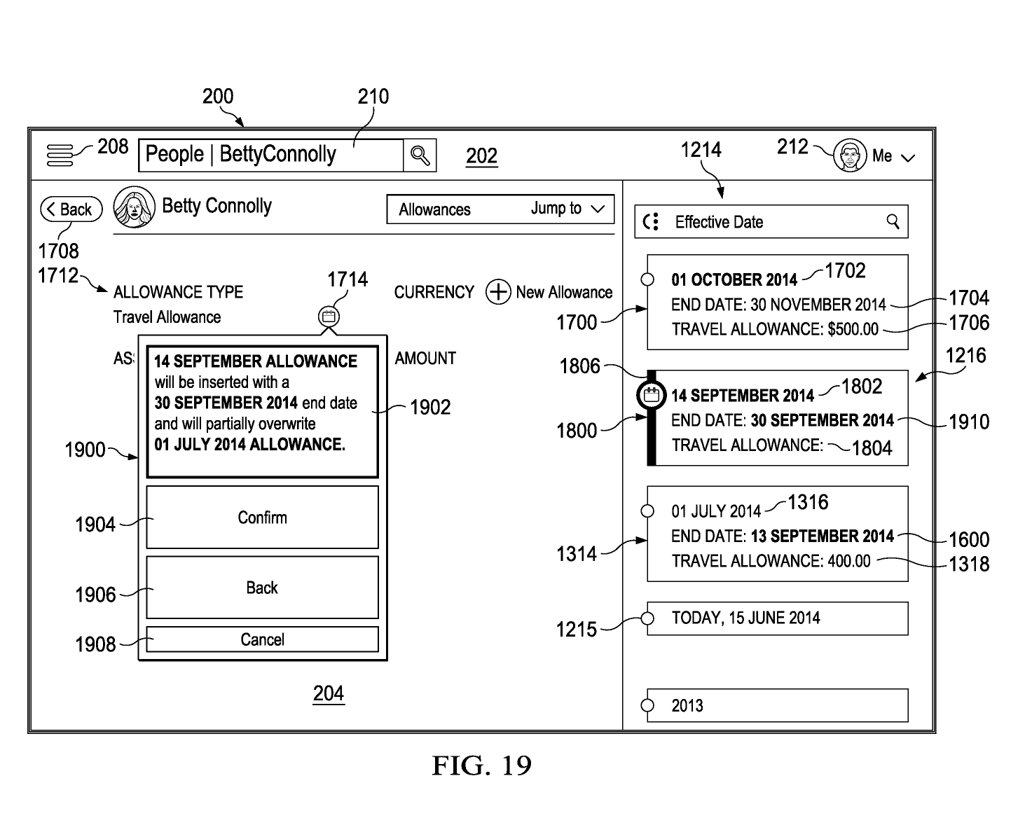

With reference now to FIG. 19, an illustration of an insertion action is depicted in accordance with an illustrative embodiment. In this illustrative example, the display in graphical user interface 200 has been updated based on user input selecting insert button 1812 in FIG. 18. The selection of insert button 1812 in FIG. 18 is a selection of an insertion action. This selection results in the display of pop-up window 1900.

Pop-up window 1900 includes graphical feature 1902, confirm button 1904, back button 1906, and cancel button 1908. Graphical feature 1902 includes text that identifies the adjustments that will be made if the insertion action is performed.

A selection of confirm button 1904 by user input will confirm the insertion action. A selection of back button 1906 by user input will cause reverting of graphical user interface 200 back to the display shown in FIG. 18, thereby cancelling the insertion action. A selection of cancel button 1908 by user input will cancel the creation of the new travel allowance event.

Further, the update to graphical element 1800 that would occur with a selection of confirm button 1904 is previewed. This update includes modifying the effective end date for the travel allowance event represented by graphical element 1314 and modifying the effective end date for the new travel allowance event represented by graphical element 1800. As depicted, the new effective end date for the new travel allowance event is identified in text object 1910 that has been added to graphical element 1800. In this illustrative example, graphical feature 1806 remains associated with graphical element 1800.

In other illustrative examples, a different update may be performed with the insertion action. For example, the update may modify the effective periods of one or more of the travel allowance events represented by graphical element 1314, graphical element 1800, and graphical element 1700 in some other manner.

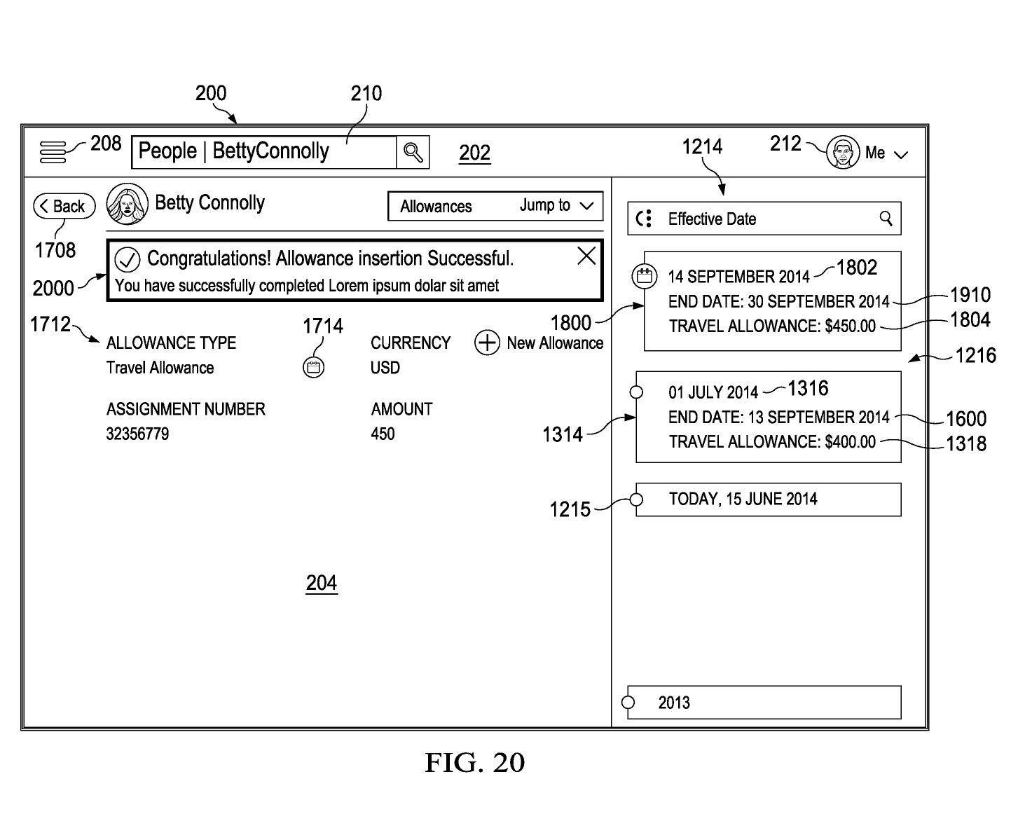

With reference now to FIG. 20, an illustration of a completion of an insertion action is depicted in accordance with an illustrative embodiment. In this illustrative example, the display in graphical user interface 200 is updated based on receiving user input selecting confirm button 1904 in FIG. 19, confirming the insertion action.

As depicted, graphical feature 1806 from FIGS. 18-19 is no longer associated with graphical element 1800. Graphical feature 2000 is displayed within main section 204 of graphical user interface 200 indicating that the insertion action has been successfully completed.

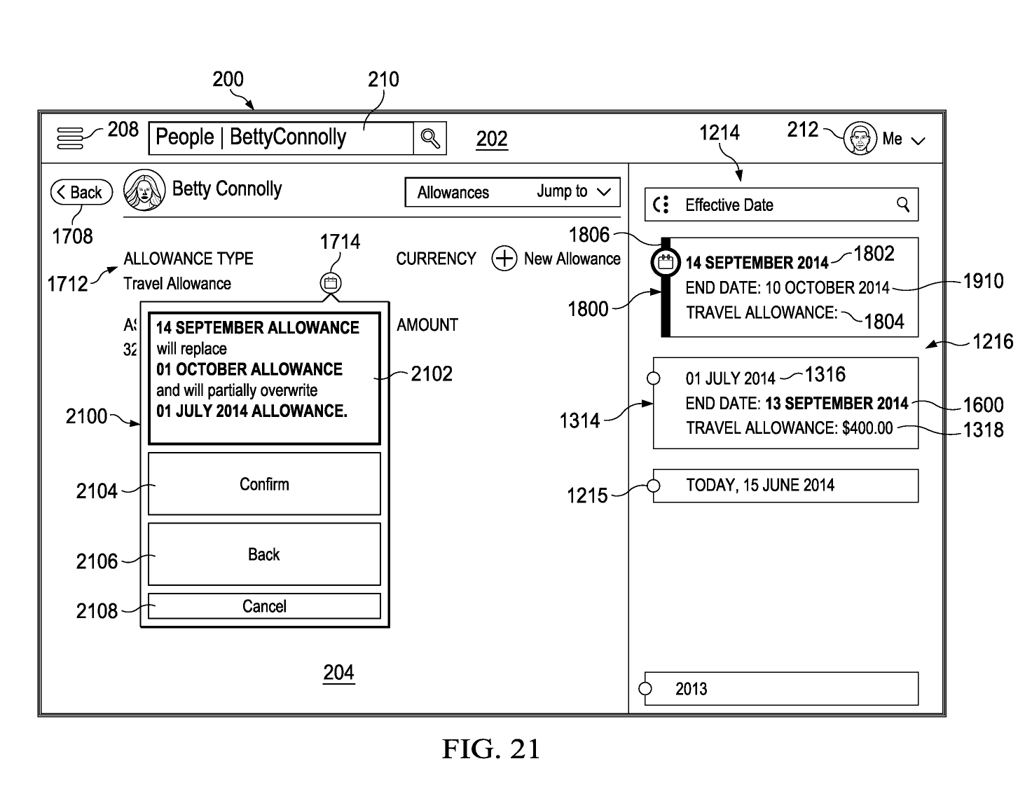

With reference now to FIG. 21, an illustration of a replacement action is depicted in accordance with an illustrative embodiment. In this illustrative example, the display in graphical user interface 200 has been updated based on user input selecting replace button 1814 in FIG. 18. The selection of replace button 1814 in FIG. 18 is a selection of a replacement action. This selection results in the display of pop-up window 2100.

Pop-up window 2100 includes graphical feature 2102, confirm button 2104, back button 2106, and cancel button 2108. Graphical feature 2102 includes text that identifies the adjustments that will be made if the replacement action is performed.

A selection of confirm button 2104 by user input will confirm the replacement action. A selection of back button 2106 by user input will cause reverting of graphical user interface 220 back to the display shown in FIG. 18, thereby cancelling the replacement action. A selection of cancel button 2108 by user input will cancel the creation of the new travel allowance event.

Further, the update to graphical element 1800 that would occur with a selection of confirm button 2104 is previewed. As depicted, if the replacement action is performed, the new travel allowance event will retain the originally selected effective end date of Oct. 10, 2014.

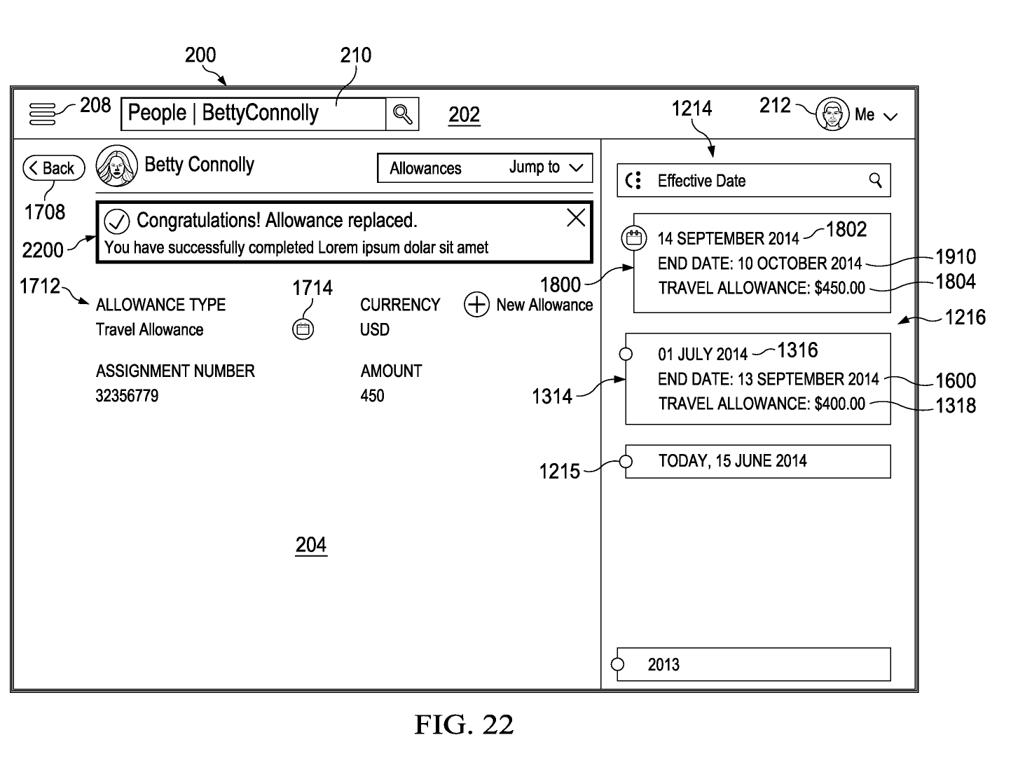

With reference now to FIG. 22, an illustration of a completion of a replacement action is depicted in accordance with an illustrative embodiment. In this illustrative example, the display in graphical user interface 220 is updated based on receiving user input selecting confirm button 2104 in FIG. 21, confirming the replacement action.

As depicted, graphical feature 1806 from FIGS. 18-19 is no longer associated with graphical element 1800. Graphical feature 2200 is displayed within main section 204 of graphical user interface 220 indicating that the replacement action has been successfully completed.

The illustrations of graphical user interface 200 in FIGS. 2-22 are not meant to imply physical or architectural limitations to the manner in which an illustrative embodiment may be implemented. Other objects, elements, or features, in addition to or in place of the ones illustrated, may be used. Some objects, elements, or features may be optional.

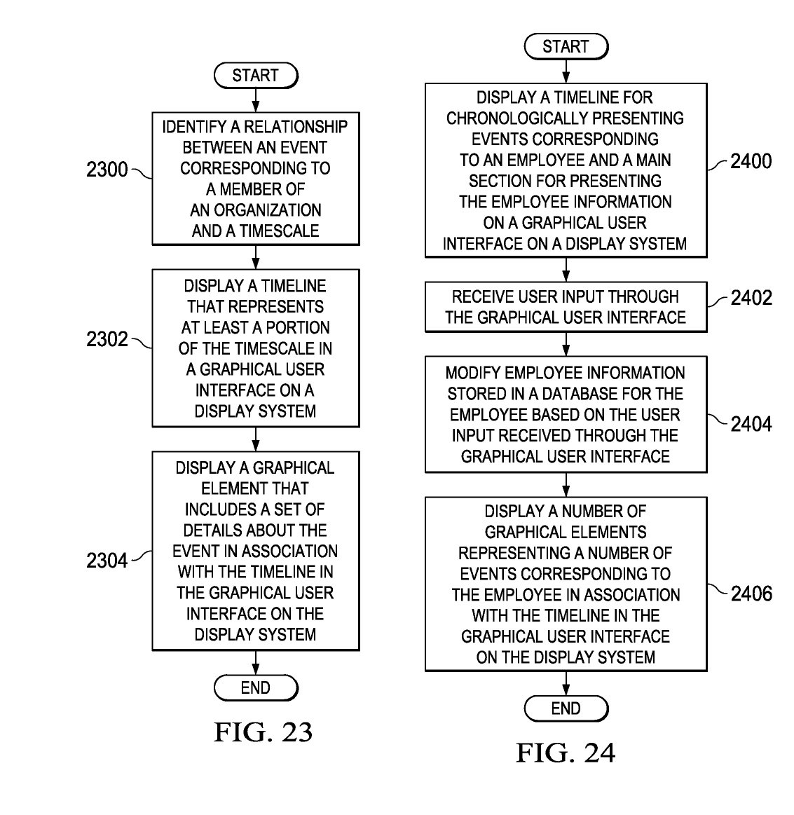

With reference now to FIG. 23, an illustration of a process for managing member information is depicted in the form of a flowchart in accordance with an illustrative embodiment. The process illustrated in FIG. 23 may be implemented using information management system 100 in FIG. 1.

The process begins by identifying a relationship between an event corresponding to a member of an organization and a timescale (step 2300). A timeline that represents at least a portion of the timescale is displayed in a graphical user interface on a display system (step 2302). A graphical element that includes a set of details about the event is displayed in association with the timeline in the graphical user interface on the display system (step 2304), with the process terminating thereafter.

With reference now to FIG. 24, an illustration of a process for managing employee information is depicted in the form of a flowchart in accordance with an illustrative embodiment. The process illustrated in FIG. 24 may be implemented using information management system 100 in FIG. 1.

The process begins by displaying a timeline for chronologically presenting events corresponding to an employee and a main section for presenting the employee information on a graphical user interface on a display system (step 2400). Next, user input is received through the graphical user interface (step 2402). Employee information stored in a database for the employee is then modified based on the user input received through the graphical user interface (step 2404). A number of graphical elements representing a number of events corresponding to the employee are displayed in association with the timeline in the graphical user interface on the display system (step 2406), with the process terminating thereafter.

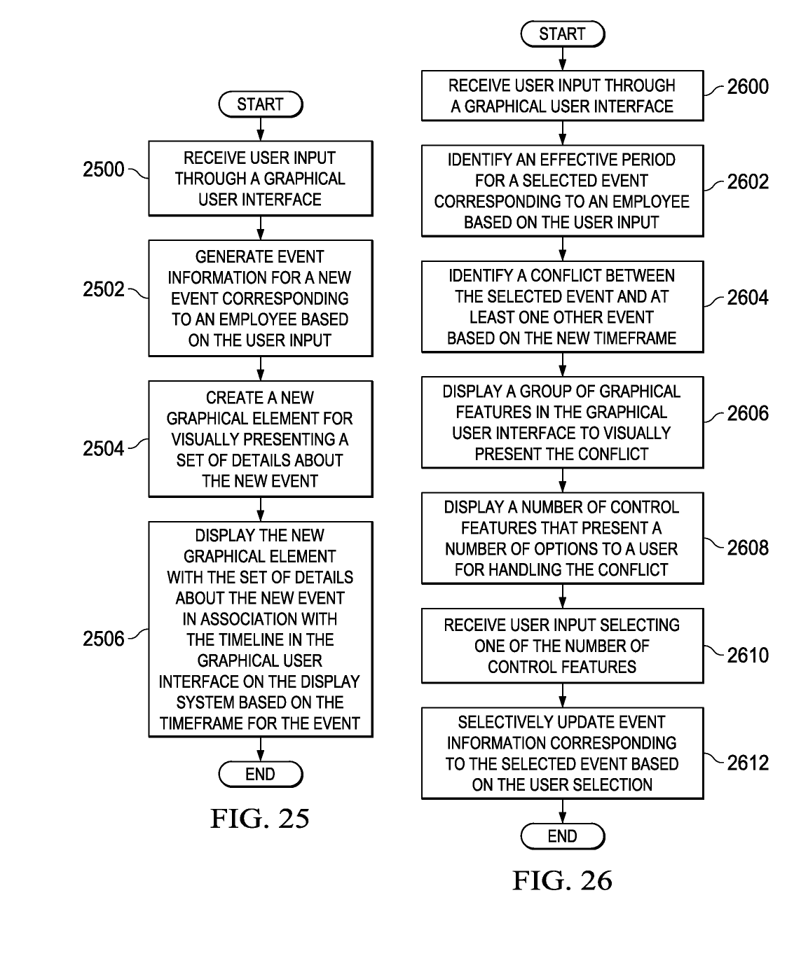

With reference now to FIG. 25, an illustration of a process for displaying a new graphical element in association with a timeline is depicted in the form of a flowchart in accordance with an illustrative embodiment. The process illustrated in FIG. 25 may be implemented using information management system 100 in FIG. 1.

The process begins by receiving user input through a graphical user interface (step 2500). Next, event information is generated for a new event corresponding to an employee based on the user input (step 2502). In step 2502, the event information includes a timeframe for the event and the event information generated becomes part of the employee information for the employee stored in a database.

Thereafter, a new graphical element is created for visually presenting a set of details about the new event (step 2504). The new graphical element is displayed with the set of details about the new event in association with the timeline in the graphical user interface on the display system based on the timeframe for the event (operation 2506), with the process terminating thereafter.

With reference now to FIG. 26, an illustration of a process for managing a conflict is depicted in the form of a flowchart in accordance with an illustrative embodiment. The process illustrated in FIG. 26 may be implemented using information management system 100 in FIG. 1.

The process begins by receiving user input through a graphical user interface (step 2600). Next, an effective period for a selected event corresponding to an employee is identified based on the user input (step 2602). Thereafter, a conflict between the selected event and at least one other event is identified based on the new timeframe (step 2604). A group of graphical features is displayed in the graphical user interface to visually present the conflict (step 2606).

Further, a number of control features that present a number of options to a user for handling the conflict are displayed (step 2608). Thereafter, user input selecting one of the number of control features is received (step 2610). Event information corresponding to the selected event is selectively updated based on the user selection (step 2612), with the process terminating thereafter. In operation 2612, the updating of the event information may include adjusting the effective period for the selected event, an effective period for an event in conflict with selected event, some other parameter, or some combination thereof in order to resolve the conflict.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks may be implemented as program code, in hardware, or a combination of the program code and hardware. When implemented in hardware, the hardware may, for example, take the form of integrated circuits that are manufactured or configured to perform one or more operations in the flowcharts or block diagrams. When implemented as a combination of program code and hardware, the implementation may take the form of firmware.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

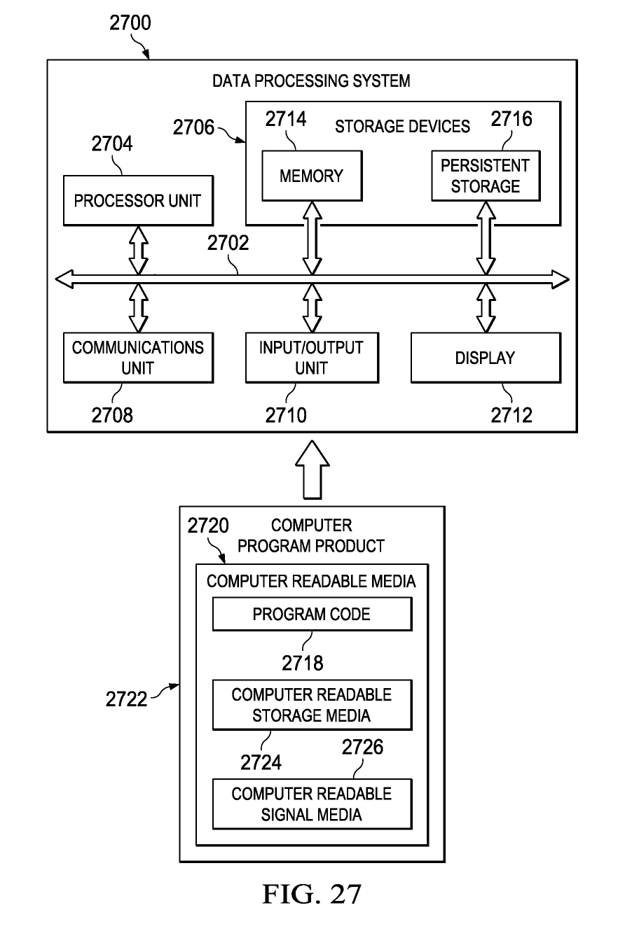

Turning now to FIG. 27, an illustration of a data processing system in the form of a block diagram is depicted in accordance with an illustrative embodiment. Data processing system 2700 may be used to implement computer system 116 in FIG. 1. As depicted, data processing system 2700 includes communications framework 2702, which provides communications between processor unit 2704, storage devices 2706, communications unit 2708, input/output unit 2710, and display 2712. In some cases, communications framework 2702 may be implemented as a bus system.

Processor unit 2704 is configured to execute instructions for software to perform a number of operations. Processor unit 2704 may comprise a number of processors, a multi-processor core, and/or some other type of processor, depending on the implementation. In some cases, processor unit 2704 may take the form of a hardware unit, such as a circuit system, an application-specific integrated circuit (ASIC), a programmable logic device, or some other suitable type of hardware unit.

Instructions for the operating system, applications, and/or programs run by processor unit 2704 may be located in storage devices 2706. Storage devices 2706 may be in communication with processor unit 2704 through communications framework 2702. As used herein, a storage device, also referred to as a computer readable storage device, is any piece of hardware capable of storing information on a temporary and/or permanent basis. This information may include, but is not limited to, data, program code, and/or other information.

Memory 2714 and persistent storage 2716 are examples of storage devices 2706. Memory 2714 may take the form of, for example, a random access memory or some type of volatile or non-volatile storage device. Persistent storage 2716 may comprise any number of components or devices. For example, persistent storage 2716 may comprise a hard drive, a flash memory, a rewritable optical disk, a rewritable magnetic tape, or some combination of the above. The media used by persistent storage 2716 may or may not be removable.

Communications unit 2708 allows data processing system 2700 to communicate with other data processing systems and/or devices. Communications unit 2708 may provide communications using physical and/or wireless communications links.

Input/output unit 2710 allows input to be received from and output to be sent to other devices connected to data processing system 2700. For example, input/output unit 2710 may allow user input to be received through a keyboard, a mouse, and/or some other type of input device. As another example, input/output unit 2710 may allow output to be sent to a printer connected to data processing system 2700.

Display 2712 is configured to display information to a user. Display 2712 may comprise, for example, without limitation, a monitor, a touch screen, a laser display, a holographic display, a virtual display device, and/or some other type of display device.

In this illustrative example, the processes of the different illustrative embodiments may be performed by processor unit 2704 using computer-implemented instructions. These instructions may be referred to as program code, computer usable program code, or computer readable program code and may be read and executed by one or more processors in processor unit 2704.

In these examples, program code 2718 is located in a functional form on computer readable media 2720, which is selectively removable, and may be loaded onto or transferred to data processing system 2700 for execution by processor unit 2704. Program code 2718 and computer readable media 2720 together form computer program product 2722. In this illustrative example, computer readable media 2720 may be computer readable storage media 2724 or computer readable signal media 2726.

Computer readable storage media 2724 is a physical or tangible storage device used to store program code 2718 rather than a medium that propagates or transmits program code 2718. Computer readable storage media 2724 may be, for example, without limitation, an optical or magnetic disk or a persistent storage device that is connected to data processing system 2700.

Alternatively, program code 2718 may be transferred to data processing system 2700 using computer readable signal media 2726. Computer readable signal media 2726 may be, for example, a propagated data signal containing program code 2718. This data signal may be an electromagnetic signal, an optical signal, and/or some other type of signal that can be transmitted over physical and/or wireless communications links.

The illustration of data processing system 2700 in FIG. 27 is not meant to provide architectural limitations to the manner in which the illustrative embodiments may be implemented. The different illustrative embodiments may be implemented in a data processing system that includes components in addition to or in place of those illustrated for data processing system 2700. Further, components shown in FIG. 27 may be varied from the illustrative examples shown.

Thus, the illustrative embodiments provide a method and apparatus for accessing employee information stored in a database. The employee information may be, for example, without limitation, searched, viewed, edited, added, deleted, or managed in some other manner using a graphical user interface for displaying the employee information.

In one illustrative example, a computer-implemented method is provided for managing employee information. A timeline for chronologically presenting events corresponding to an employee and a main section for presenting the employee information are displayed in a graphical user interface on a display system. The employee information for the employee may be stored in a database. The employee information stored in the database may be modified based on user input received through the graphical user interface. A number of graphical elements representing a number of events corresponding to the may be displayed in association with the timeline in the graphical user interface on the display system.

This type of graphical user interface and timeline provides a temporal context for the employee information that allows a user to more quickly and easily access the employee information. In particular, the timeline provides a technical solution to the problem of quickly and easily accessing employee information by enabling a user to quickly and easily ascertain the temporal context of events corresponding to employees without needing to know the specific time points related to these events. Further, the graphical user interface enables a user to quickly and easily navigate through large numbers of employee records and event records, while maintaining a visual presentation of the temporal context for these records through the timeline displayed in the graphical user interface.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component may be configured to perform the action or operation described. For example, the component may have a configuration or design for a structure that provides the component an ability to perform the action or operation that is described in the illustrative examples as being performed by the component.

Many modifications and variations will be apparent to those of ordinary skill in the art. Further, different illustrative embodiments may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A method for managing employee information, the method comprising:
displaying, by a computer system, a timeline for chronologically presenting events corresponding to an employee and a main section for presenting the employee information in a graphical user interface on a display system;
modifying, by the computer system, the employee information for the employee stored in a database based on user input received through the graphical user interface; and
updating, by the computer system, a number of graphical elements representing a number of events corresponding to the employee that are displayed in association with the timeline in the graphical user interface on the display system,
wherein the timeline provides a temporal context for the employee information that allows a user to more quickly and easily access the employee information.

2. The method of claim 1, wherein updating comprises:
updating, by the computer system, the number of graphical elements displayed in association with the timeline and detailed information corresponding to the employee displayed within the main section in the graphical user interface.

3. The method of claim 1, wherein modifying comprises:
generating, by the computer system, event information for a new event corresponding to the employee based on the user input, wherein the event information includes a timeframe for the event and wherein the event information becomes part of the employee information for the employee.

4. The method of claim 3, wherein updating comprises:
creating, by the computer system, a new graphical element for visually presenting a set of details about the new event; and
displaying, by the computer system, the new graphical element with the set of details about the new event in association with the timeline in the graphical user interface on the display system based on the timeframe for the event.

5. The method of claim 1, wherein modifying comprises:
changing, by the computer system, a timeframe for a selected event corresponding to the employee to a new timeframe based on the user input.

6. The method of claim 5, wherein updating comprises:
changing, by the computer system, a placement of a graphical element that represents the selected event with respect to the timeline based on the new timeframe.

7. The method of claim 5, wherein updating comprises:
identifying, by the computer system, a conflict between the selected event and at least one other event based on the new timeframe; and
displaying, by the computer system, a number of graphical features in association with the graphical element in the graphical user interface to visually indicate the conflict.

8. The method of claim 7 further comprising:
displaying, by the computer system, a number of control features that present a number of options to the user for handling the conflict; and
updating selectively, by the computer system, event information corresponding to the selected event based on a user selection of one of the number of control features.

9. The method of claim 1 further comprising:
detecting, by the computer system, a selection of a graphical element associated with the timeline in the graphical user interface, wherein the graphical element represents an event corresponding to the employee; and
displaying, by the computer system, detailed information corresponding to the employee within the main section in the graphical user interface on the display system.

10. The method of claim 9, wherein the detailed information includes at least one of an employment status, an allowance amount, an address, an age, a marital status, an education level, a job title, an experience level, a compensation level, bonus information, a tenure status, an effective start date, or an effective end date.

11. A method for managing member information about members of an organization, the method comprising:
displaying, by a computer system, a timeline that represents at least a portion of a timescale in a graphical user interface on a display system;
displaying, by the computer system, a graphical element that visually presents a portion of the member information about an event in association with the timeline based on a relationship between the event and the timescale in the graphical user interface on the display system; and
updating, by the computer system, the graphical element based on user input received through the graphical user interface,
wherein the timeline provides a temporal context for the member information that allows a user to more quickly and easily access the member information.

12. The method of claim 11 further comprising:
receiving, by the computer system, the user input through interaction between the user and a number of control features within the graphical element.

13. The method of claim 12 further comprising:
changing, by the computer system, at least one of a set of details about the event stored in a database based on the user input to form a modified set of details.

14. The method of claim 13, wherein updating the graphical element comprises:
updating, by the computer system, the graphical element to visually present the modified set of details within the graphical element in the graphical user interface on the display system.

15. The method of claim 12 further comprising:
displaying, by the computer system, at least a portion of the member information corresponding to at least one of the member of the organization within a main section of the graphical user interface on the display system based on the user input.

16. The method of claim 11, wherein the displaying, by the computer system, the graphical element comprises:
displaying, by the computer system, a number of graphical features in the graphical user interface on the display system, wherein the number of graphical features includes at least one of a text object, a symbol, an image, a control feature, an icon, or a graphical indicator.

17. The method of claim 11, wherein displaying, by the computer system, the timeline comprises:
displaying, by the computer system, one of a linear element a curved bar, and a circular bar to represent the timescale in the graphical user interface on the display system.

18. The method of claim 11 further comprising:
identifying, by the computer system, the relationship between the event and the timescale, wherein the event corresponds to one of the members of the organization.

19. The method of claim 18, wherein identifying, by the computer system, the relationship comprises:
identifying, by the computer system, at least one of a start time point or an end time point for the event with respect to the timescale.

20. A computer system comprising:
a display system; and
an information manager in communication with the display system, wherein the information manager identifies a relationship between an event corresponding to a member of an organization and a timescale; displays a timeline that represents at least a portion of the timescale in a graphical user interface on the display system; and
displays a graphical element that includes a set of details about the event in association with the timeline in the graphical user interface on the display system.

21. The computer system of claim 20, wherein the information receives user input entered by a user through a number of input devices.

22. The computer system of claim 20, wherein the information manager manages member information corresponding to the member of the organization within a main section of the graphical user interface on the display system based on a user input, wherein the member information includes the set of details about the event corresponding to the member.

23. The computer system of claim 20, wherein the graphical element displayed in the graphical user interface includes a number of graphical features and wherein the number of graphical features includes at least one of a text object, a symbol, an image, a control feature, an icon, or a graphical indicator.

24. The computer system of claim 20, wherein the timeline includes one of a linear element, a curved bar, and a circular bar that represents the timescale.

25. A computer system comprising:
a display system; and
an information manager in communication with the display system, wherein the information manager displays a timeline for chronologically presenting events corresponding to an employee and a main section for presenting employee information on a graphical user interface on the display system; modifies the employee information for the employee stored in a database based on user input received through the graphical user interface; and updates a number of graphical elements representing a number of events corresponding to the employee that are displayed in association with the timeline in the graphical user interface on the display system.

26. A computer program product for managing employee information, the computer program product comprising:
a computer readable storage media;
first program code, stored on the computer readable storage media, for identifying a relationship between an event corresponding to a member of an organization and a timescale;
second program code, stored on the computer readable storage media, for displaying a timeline that represents at least a portion of the timescale using a graphical user interface on a display system; and
third program code, stored on the computer readable storage media, for displaying a graphical element that includes a set of details about the event in association with the timeline in the graphical user interface on the display system.

27. The computer program product of claim 26 further comprising:
fourth program code, stored on the computer readable storage media, for changing, by a computer system, at least one of the set of details about the event stored in a database based on user input to form a modified set of details.

28. The computer program product of claim 27 further comprising:
fifth program code, stored on the computer readable storage media, for displaying, by the computer system, the modified set of details within the graphical element in the graphical user interface on the display system.
